(19) United States
(12) Patent Application Publication
(10) Pub. No.: US 2022/0374430 A1
(43) Pub. Date: Nov. 24, 2022

(54) SYSTEM AND METHOD FOR INCREMENTAL VIEW MAINTENANCE BASED ON DIFFERENTIAL CALCULUS OVER NATURAL ALGEBRA OF K-RELATIONS

(71) Applicant: Starcounter AB, Stockholm (SE)

(72) Inventors: Andrey Andreev, Sollentuna (SE); Henrik Sjöström, Lidingo (SE)

(21) Appl. No.: 17/733,440

(22) Filed: Apr. 29, 2022

Related U.S. Application Data
(60) Provisional application No. 63/182,173, filed on Apr. 30, 2021.

(51) Int. Cl. G06F 16/2453

(52) U.S. Cl. CPC G06F 16/24535; G06F 16/24542; G06F 17/13

(57) ABSTRACT

A method for incremental update of materialized views and a system for answering queries against relational databases, or object-oriented databases, or graph databases, are provided. The system comprises a Storage Engine subsystem, configured to store original data as well as materialized views and subviews in a dedicated subsystem, and a Diff Engine subsystem configured to translate Natural Algebra representations of a Natural Algebra view definition into derived Natural Algebra expressions. The system further comprises an Optimizer configured to translate derived Natural Algebra expressions into Incremental View Maintenance plans, and a Delta Extractor subsystem configured to extract any transactional changes to the original data or batches of the said changes in a form that can be passed as input to the Incremental View Maintenance plans in order to compute the changes to the materialized views.

### CROSS-REFERENCE TO RELATED APPLICATIONS

The present application is related to PCT Application No. PCT/SE2020/051049, filed Oct. 29, 2020, titled “System and Method for Relational Database Query Answering and Optimization Based on Natural Algebra of K-Relations,” which claims priority to Swedish Patent Application No. 1951327-4, filed Nov. 18, 2019 and to Swedish Patent Application No. 1951327-4, filed Nov. 1, 2019, titled “System and Method for Relational Database Query Answering and Optimization Based on Natural Algebra of K-Relations,” and claims priority to U.S. Provisional Patent Application 63/182,173, filed Apr. 30, 2021, titled “system and method for incremental view maintenance based on differential calculus over natural algebra of K-relations,” the entireties of the all of which are incorporated herein by reference.

### FIELD

The present disclosure relates to a device, system and method for incrementally updating materialized views over relational databases, object-relational databases, and graph databases.

### BACKGROUND

In PCT Application No. PCT/SE2020/051049 and Swedish Patent Application No. 1951327-4, we defined Natural Algebra, as an intermediate representation of database queries specified in a number of query languages, such as SQL, LINQ, and their extensions over relational, object-relational, and graph databases. Natural Algebra defines only two basic operators, natural join and natural union, and regards the data being queried as a collection of named k-relations, which preserve information about any duplicate records or object instances. The original purpose of Natural Algebra is to allow for lean and efficient query optimization defined by a relatively small number of optimization rules.

Database views are defined in terms of database queries. While non-materialized views can be regarded as named subqueries, materialized views are pre-computed copies of the selected and restructured data, readily available for further querying by the database applications. They are maintained in order to speed up database read operations, especially in cases of high selectivity, large number of joins, grouping and aggregation, or other expensive data processing. However, materialized views need to be updated on every update to the original data in an efficient way. Particular efficiency concerns are minimizing the amount of irrelevant update triggers, and identifying updates which actually change the data in the view. This is known as incremental view maintenance (IVM) problem.

A number of studies cover incremental view maintenance with respect to database views expressed by queries based on relational algebra. Relational algebra is set-oriented, which means that the information about duplicate records or objects is not maintained, in contrast to our model. Most solutions imply a certain amount of false-positive update triggering; as in this model it is hard to identify all the cases where certain changes to the original data do not lead to changes in the materialized view.

Additionally, set-oriented database algebras carry the burden of duplicate removal (e.g. on projection), so the runtime might normally diverge from the algebra in many cases where de-duplication is not practical. This also makes certain operations more mathematically complicated and less suitable for tracking and propagating the changes.

### SUMMARY

Embodiments presented herein offer the advantage of computing the exact changes to the materialized views, based on the changes to the original data. This applies to the materialized views defined by all kinds of queries against relational databases, object/relational databases, and graph databases.

According to the first aspect, there is provided a system for answering queries against relational databases, or object-oriented databases, or graph databases, capable of utilizing the information stored in the materialized views, and incrementally maintaining the said materialized views.

The system comprises a Storage Engine subsystem configured to store original data as well as materialized views and subviews in a dedicated subsystem. The process of answering a database query consists of first translating it to its Natural Algebra representation, then building a query plan, and executing the said query plan against the database instance, possibly extended with materialized views, in order to obtain the query answer. Materialized views offer a benefit of speeding up queries that rely on them, and potentially, more queries can be transformed to use them. A database transaction involves the similar steps of obtaining a Natural Algebra representation, producing a transaction plan, and executing the said plan against the database instance. However, materialized views need to be updated in the process of updating the original data in the database.

The system further comprises a Diff Engine subsystem configured to translate Natural Algebra representations of a view definition into derived Natural Algebra expressions, which can be further translated by the optimizer into the Incremental View Maintenance plans. The Diff Engine allows solving the Incremental View Maintenance problem in an efficient way, by directly computing the update to the materialized views based on the updates of to the base tables. This reduces the amount of materialized view rows updated, compared to complete or partial view re-computation techniques known so far, including those techniques which identify a set of candidate rows in the materialized view which can be affected by a change in the base tables. The ability to compute and apply the exact update to the materialized view arises from the use of multiset-based Natural Algebra, instead of the set-based relational algebra, and is based on the idea of computing the derived Natural Algebra expression, which is explained in Section 2 of this disclosure, and performed by the Diff Engine subsystem.

The system further comprises an Optimizer configured to translate derived Natural Algebra expressions into the efficient Incremental View Maintenance plans, in addition to its usual job of translating Natural Algebra representations of database queries, including those constituting transactions, into the efficient query plans. The initial population of the materialized views is done in the same way as query answering, by optimizing the Natural Algebra view expression to an efficient population plan, and then executing it against the database instance.

The system further comprises a Delta Extractor subsystem configured to extract any transactional changes to the original data or batches of the said changes in the form of delta k-relations which are then passed as input to the Incremental View Maintenance plans in order to compute the changes to the materialized views.

The Diff Engine subsystem may be further configured to handle aggregate views by producing definitions of the aggregate subviews to materialize, wherein aggregate views are views containing calls to aggregate functions, grouping operator, and distinct operator. This extends our approach to Incremental View Maintenance over aggregate materialized views, which, in general, can not be incrementally updated relying only on the derived expressions and the extracted deltas.

The aggregate subviews to materialize may further form a directed acyclic graph of dependencies, with input nodes corresponding to the stored tables, and the output node corresponding to the original user-defined aggregate view, so that all these aggregate views may be updated incrementally with the aggregate update algorithm where changes are propagated from the input nodes towards the output node. This extends our approach to Incremental View Maintenance over aggregate views which are defined in terms of nested aggregate views or subqueries.

According to a further aspect, there is provided a method for incremental update of materialized views expressed by queries against relational databases, or object-oriented databases, or graph databases.

This method, in case of materialized views whose definitions do not contain aggregation, grouping, or distinct operator, comprises producing derived expressions for each base table in the view definition, allocating the materialized views in the storage, populating these materialized views according to the view definitions, and extracting the changes to the original tables each time a transaction commits. Every time there is a non-empty change to any of the original tables, the materialized views are incrementally updated by evaluating the derived expressions using the said changes to the original tables. This produces the less updates to the materialized views, and involves less computations, compared to other methods of maintaining materialized views, such as total or partial recomputation, the latter including techniques of identifying the materialized view rows which can be affected by a change in the base tables.

The method is further equipped for maintaining materialized views whose definitions contain as a top operator an aggregate function call, or a grouping operator, or a distinct operator. The method may then further comprise extending the aggregate function in the view definition with Count column, counting all, possibly duplicate, tuples comprising each group, in case the said aggregate function does not yet contain such Count column, and allocating the aggregate materialized views in the storage, populating the said aggregate materialized views according to the extended view definitions, and each time a transaction commits, incrementally updating the said aggregate materialized views with an aggregate update algorithm, which identifies only those rows in the said views which receive a change in result of a given update. This is an extension of our method, and adding Count column, in particular, allows to efficiently detect cases when a certain group produced by a grouping operator becomes empty after an update.

The method is further equipped for maintaining materialized views whose original definitions may contain any number of aggregate function calls, grouping operators, and distinct operator at arbitrary levels, including nested views and subqueries. The method then involves extracting from the original materialized view definition definitions for aggregate subviews, each aggregate subview containing a single aggregate function call, grouping, or distinct operator on top of its expression, and some aggregate subviews dependent on other aggregate subviews, thus forming a directed acyclic graph of dependencies. This is another extension of our method, and updating a directed acyclic graph of aggregate subviews is a computation- and memory-efficient way of handling such materialized views.

Each time a transaction commits, the method incrementally updates each of the said materialized subviews with the aggregate update algorithm, starting with materialized subviews which do not depend on other materialized subviews, and then propagating the resulting changes to the next layer of subviews in the dependency graph, and either incrementally updating the original materialized view if it was allocated in the storage, or re-evaluating the original view definition now expressed in terms of the materialized subviews, in the latter case obtaining a cheap to execute on-demand view. The latter alternative is drastically more memory-efficient, in certain cases, especially for the views with involve join operations over the result of grouping and aggregation.

According to a further aspect there is provided a computer program loadable into a memory communicatively connected or coupled to at least one data processor, comprising instructions for executing the method according to any of the embodiments presented herein when the program is run on the at least one data processor.

According to yet another aspect there is provided processor-readable medium, having a program recorded thereon, where the program is configured to make at least one data processor execute the method according to of any of the embodiments presented herein when the program is loaded into the at least one data processor.

### BRIEF DESCRIPTION OF THE DRAWINGS

The invention is now to be explained more closely by means of preferred embodiments, which are disclosed as examples, and with reference to the attached drawings.

FIG. 1 shows a schematic overview of a system according to one or more embodiments;

FIG. 2 is a flow chart of a method according to one or more embodiments.

### DETAILED DESCRIPTION

### 1. Introduction

The present disclosure describes a system and method for the incremental maintenance of the materialized views expressed as queries against relational databases, or any databases which expose (are mapped to) the relational data model. Such queries are translated to the Natural Algebra expressions, consisting of operators, constant k-relations, and named variables for the base k-relations used in the query.

The sections 1.1-1.3 below provide an introduction to, and the basic definitions of Natural Algebra. Examples throughout this disclosure illustrate the translation from SQL to the Natural Algebra expressions. Section 1.4. briefly introduce the concept of a delta of a k-relation, including a delta of a maintained view. Section 1.5 provides an overview of the system and method which are subjects to this disclosure.

1.1. Tuples and k-Relations

In Natural Algebra the queriable data is represented by k-relations, which are multisets of tuples of named values. Tuples map named attributes to the values of the respective domains, for example, t= [symbol] name→John′, age→32 [symbol] (despite the angular brackets notation, the order of the mappings does not matter), and k-relations map a set of tuples to numeric-valued multiplicities, for example, A={t*1, u*3}. In our notation we normally omit specifying multiplicity if it is 1, so A={t, u*3}.

Definition 1.1. K-relation and multiplicity. k-relation A={t₁, . . . , tₘ}_{X} is a multiset of tuples with explicitly specified header X. The membership function k_{A}(t)→Z has integer range, though it can be easily extended to real-valued membership (fuzzy/probabilistic/measured multisets). k_{A}(t) is also called multiplicity of tuple tin k-relation A.

We say that a k-relation contains a tuple, tϵA if and only if its multiplicity is non-zero: k_{A}(t)≠0.

An equivalent way of defining k-relations would be to attribute multiplicities k(t) to tuples per se, thus defining k-tuples, [symbol] a→a(t), b→b(t), . . . , k(t) [symbol] , and k-relations would be sets of such k-tuples. All the definitions given below can be re-reformulated based on such formalism as well, but the theorem proofs would become more complex, since they will have to deal with multiple equivalent set representations of the same k-relation.

The header H(t) of a tuple is the set of all attributes which it maps to values, but the header H(A) of a k-relation is always explicitly given as part of its definition. For example, if a k-relation represents a table in a relational database, the header of such k-relation is the set off its column names and the associated data types. This also allows empty k-relations Ø_{X}, with a specified header X. A tuple may also be empty, as denoted by [symbol] , and a k-relation containing only an empty tuple with multiplicity n is called a scalar k-relation: { [symbol] *n}.

We regard base tables/classes in the database as k-relations (denoted as A, B, C . . . ,). A query result is also a k-relation, as well as the contents of database views (denoted as V, W . . . ). All kinds of changes (i.e. insertion, update, and deletion of rows/instances) to the base tables/classes are also expressed by k-relations ΔA, ΔB, ΔC, . . . , where certain multiplicities can be negative.

Definition 1.2. Positive k-relation. A k-relation A is positive if and only if all contained tuples have positive multiplicity.

∀tϵA: k(t)>0.

Theorem 1.3. Any k-relation A can be expressed as A=A⁺−A⁻ where both A⁺ and A⁻ are positive k-relations.

Views are defined by queries, which are Natural Algebra expressions over the base k-relations: V=q(A, B, C, . . . ).

Definition 1.4. Flat k-relation. A k-relation A is flat if and only if all contained tuples have multiplicity of 1.

∀tϵA: k(t)=1.

### 1.2 Natural Join

One basic operation on k-relations is natural join [symbol] which produces a k-relation consisting of joined pairs of the compatible tuples from the argument k-relations. Two tuples are compatible t↔u if and only if they map the same attributes to the same values, for example:

t= [symbol] name→‘John’,age→32 [symbol] and v= [symbol] name ‘John’,ssn→1234 [symbol] .

Definition 1.5. Tuples t and u are compatible, if and only if they map the same attributes to the values:

t↔u⇔∀aᵢϵH(t)∩H(u): aᵢ(t)=aᵢ(u)

By joining compatible tuples we obtain a tuple containing union of the mappings: t·v= [symbol] name→‘John’, age→32, ssn→1234 [symbol] .

Definition 1.6. Tuple join t·u is only defined if tuples are compatible.

t·u= [symbol] t∪u

[symbol]

In particular, two tuples with non-overlapping headers are always compatible, and their join is always defined (as a union of non-overlapping sets). Also, since mappings in the tuple are not ordered, tuple join is commutative:

t·v=v·t.

Definition 1.7. Natural join operation over two k-relations joins all pairs of the compatible tuples from its left and right arguments, and multiplies their respective multiplicities:

A [symbol] B={t·u*k_{A}(t)·k_{B}(u): tϵA∧uϵB∧t↔u}

The header of the result of a natural join is defined as union of headers of its operands:

H(A [symbol] B)=H(A)∪H(B)

Natural join operation is commutative and associative, and uses scalar k-relation { [symbol] *1} as the identity element. Therefore Natural Algebra is a commutative monoid with respect to the natural join operation.

We also extend the natural join operation to the tuple argument:

t [symbol] A={t} [symbol] A

and to the scalar multiplication:

n·A={ [symbol] *n} [symbol] A

Different embodiments may include different implementations of the natural join operation, depending on the internal representation of k-relations, available access paths to tuples with specified values (i.e. database indexes), and other technical choices. The most common examples are nested-loop join (either using scans or index lookups), hash join, and sort-merge join,

More optimized implementations of join operation may be included for the specialized cases, such as joining under many-to-one guarantee, which is typically provided by non-nullable foreign keys in the relational databases, or for joining sets of nodes/objects which directly link one to another, as is usually the case in graph databases/object stores.

### 1.3 Natural Union

Another basic operation is natural union+ producing a k-relation containing the ‘common’ parts of all tuples in the argument k-relations, with the multiplicities of the matching tuples summed up.

Definition 1.8. Natural union operation over two k-relations projects them to the common header and contains the projected tuples from both operands, summing up the respective multiplicities:

A+B={t*(k_{Π}_{ₓ}_{(A)})(t)+k_{Π}_{ₓ}_{(B)})(t)): tϵDom(X)}

where X is the common set of attributes of the operand k-relations, which is also the header of the result of the natural union:

X=H(A=B)=H(A)∩H(B)

For example, the natural union of k-relations each containing a single instance of tuple t and v from the previous example, would contain two instances of tuple mapping the only common attribute: {t}+{v}={ [symbol] name→‘John’ [symbol] *2}.

Natural union operator is commutative and associative, and uses empty k-relation Ø_{Ω} with the universal header Ω as the identity element. Therefore Natural Algebra is a commutative monoid with respect to the natural union operation. We do not claim the inversibility property of the natural union operator (which would make Natural Algebra an abelian group w.r.t. this operator). Even though for each k-relation A there exists an ‘inverse’ k-relation−A={ [symbol] *−1} [symbol] A, the result of natural union A+(−A)=Ø_{H(A)} depends on the header of A, and does not produce the aforementioned identity element Ø_{Ω}.

The domain Dom(X) is the (potentially infinite) set of all possible tuples with header X. Though the definition above implies running t through an infinite domain, any embodiment will have to include a finite-time and finite-space implementation of the natural union. This is certainly possible, since parts of only those tuples which are contained in at least one of the operands will get a non-zero multiplicity in the result of the natural union.

The above notation assumes that attributes are identified by name and domain, i.e. there cannot be attributes with same names but different domains in headers of k-relations. However, this is not the case in the classical relational databases, as one can define tables with homonymic columns of different types, and then try to compute a relational union of such tables. Embodiments which are designed to be compatible with existing database management systems supporting SQL need a specific implementation of natural union, which would emulate the behavior of SQL union operation in this aspect—either throwing an error if the domains are different, or trying to construct common wider domain for the respective attribute in X.

### 1.4. Deltas

Throughout this disclosure, database queries originally expressed in SQL are represented by the Natural Algebra expressions q(A, B, C, . . . ), where the arguments are the base tables. Database views are effectively named queries, which can be used in the FROM clause of other queries, or, once translated to Natural Algebra, as arguments to other Natural Algebra expressions.

Definition 1.9. Database view V=q(A, B, C, . . . ) is a Natural Algebra expression q(A, B, C, . . . ), with k-relation arguments A, B, C . . . which can be referred to as V.

Whenever a k-relation A changes, this change can be represented by a k-relation ΔA, where added tuples are included with positive multiplicities, deleted tuples with negative multiplicities, and changed tuples are treated as pairs of deleted and added tuples, typically with the same key (Table 2.4 provides an example of an updated row). The new k-relation is obtained as a natural union A+ΔA.

Definition 1.10. Delta. Any number of insertions, deletions, and updates to tuples in a k-relation A can be represented by a k-relation AA (with same header as A, and possibly negative multiplicities), and the k-relation resulting from this update is obtained as A+ΔA.

While the stored k-relations are typically big, the deltas resulting from a particular transaction are normally small. Any derived changes based on these deltas are also expected to be small.

Definition 1.11. Delta of an expression. Given a set of argument k-relations, and (without loss of generality, as follows from the Theorem 1.12 below), the change ΔA to one of them, delta Δ_{A} of the expression q(A, B, C, . . . ) is the effective change to the result of this expression, represented as a k-relation, and depending on the expression arguments and the change ΔA:

Δ_{A}q(A,B,C, . . . )=q(A+ΔA,B,C, . . . )−q(A,B,C, . . . )

For each Natural Algebra expression q(A, B, C, . . . ) and its base variable A the derived expression q^{(A)} (A, ΔA, B, C, . . . ) can be constructed, as shown in the remaining sections. This result is the essential part of our method for maintaining incremental views. Being applied to a particular change AA and the last snapshot A, B, C . . . of the relevant part of the database, the result of this derived expression is equal to the corresponding change of a view:

Δ_{A}V=Δ_{A}q(A,B,C, . . . )=q^{(A)}(A,ΔA,B,C, . . . )

If the derived expression q^{(A)}(A,ΔA, B, C, . . . ) is known, it can also be used for obtaining the new result of the expression q after the change ΔA, as follows from the Definition 1.11:

q(A+ΔA,B,C, . . . )=q(A,B,C, . . . )+q^{(A)}(A,ΔA,B,C, . . . )

Theorem 1.12. If multiple arguments to an expression have changed, the corresponding new result of that expression can be computed by applying the partial derived changes in any order:

q(A+ΔA,B+ΔB)=q(A+ΔA,B)+q^{(B)}(A+ΔA,B,ΔB)==q(A,B+ΔR)+q^{(A)}(A,ΔA,B+ΔB)

This is based on the equality Δ_{A}Δ_{B}q=Δ_{B}Δ_{A}q for any Natural Algebra expression q(A, B, . . . ), which follows from the Definition 1.11.

### 1.5. The Method for Incremental View Maintenance

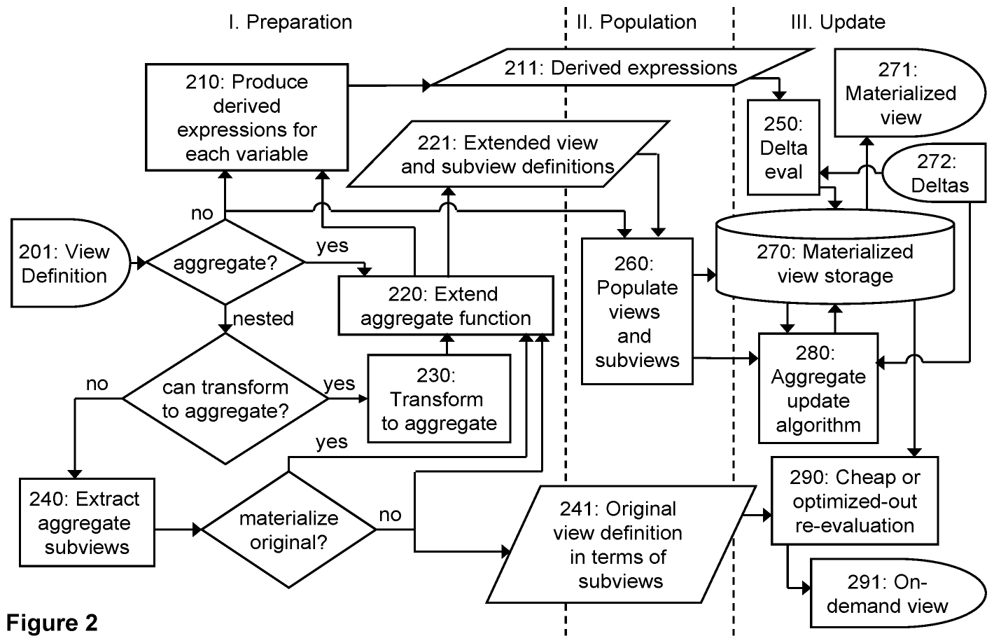

The method for incremental maintenance of a materialized view consists of the Preparation (I), Population (II), and Update (III) phases, as shown on FIG. 2.

At the Preparation phase (I) the view definition is translated to a Natural Algebra expression q(A, B, C, . . . ), and for each base k-relation A, B, C . . . the corresponding derived expression, e.g. q^{(A)} (A, ΔA, B, C) is constructed, as defined in the following sections.

At the Population phase (II) the data in the view is computed by executing the optimized equivalent of the view definition:

V=q(A,B,C, . . . )

The Update phase (III) takes place whenever any of the base k-relations for a view is updated, for example, a k-relation A receives a change ΔA. The respective change to the view V is then computed as Δ_{A}V=q^{(A)} (A,ΔA, B, C, . . . ).

Following is the detailed description of these three phases, but first we introduce the system architecture for a preferred embodiment of this invention.

### 1.5.1. System Overview

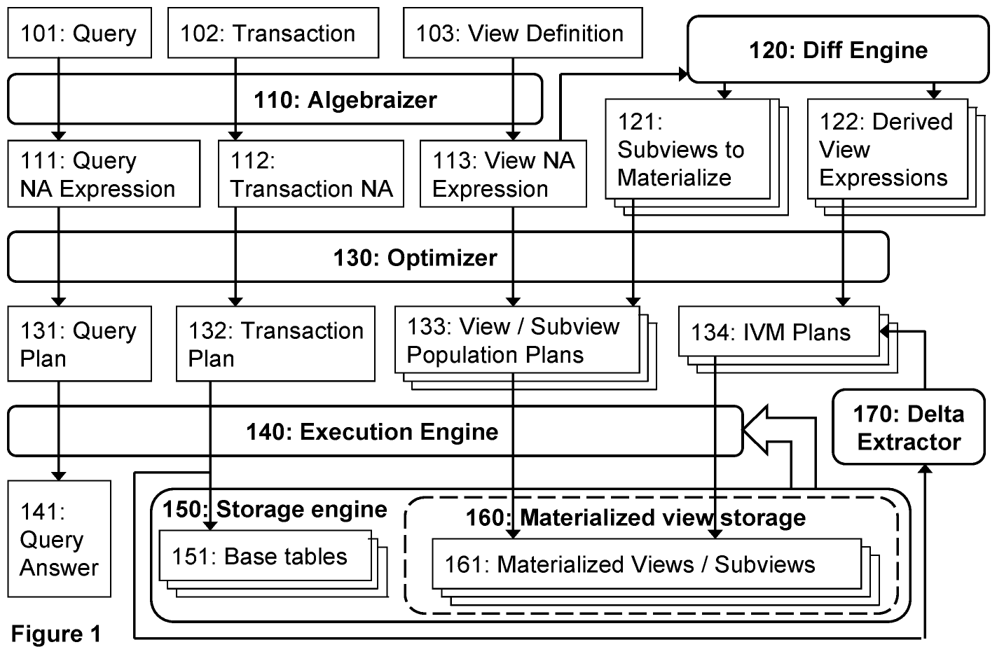

As shown on FIG. 1, the system for answering queries and incrementally maintaining materialized views comprises Algebraizer 110, Optimizer 130, Execution Engine 140, and Storage Engine 150, which are traditional components in database management system architectures, where a component similar to Algebraizer 110 of this disclosure translates queries, updates, and view definitions to their intermediate representations. In systems maintaining materialized views, the storage system effectively hosts a materialized view storage 160.

One novel part of this invention is Diff Engine 120. For each view definition in the form of Natural Algebra expression 113, Diff Engine 120 generates derived view expressions 122, one for each base table or materialized view involved. In case of aggregate views it will also extract subview definitions 121 which need to be materialized along or instead of original view 113, these alternatives are discussed in Section 4.

The Optimizer 130 translates different kinds of Natural Algebra expressions into execution plans, including query plans 131, update plans 132, view and subview population plans 133, and incremental view maintenance (IVM) plans 134. While a derived view expression algebraically depends on a delta to a respective base table, an IVM plan accepts such delta as one of its inputs. The deltas are extracted during the base table updates by another novel component of this disclosure—Delta Extractor 170.

### 1.5.2. Preparation Phase

The Preparation phase (I) takes place when the materialized view is set up in the system. The phase (I) part of the flow chart on FIG. 2 mainly explains the internals of the Diff Engine 120 component from FIG. 1. An incoming view definition 201, if not involving aggregation, grouping, or distinct operators, is used to produce derived expressions for each variable (the latter being a base table or a materialized view involved). The process 210 of producing the derived expressions for non-aggregate views is explained in Section 2 of this disclosure. The resulting derived expressions 211 are then passed directly to the update phase (III), while the original view definition 201 is passed to the view population phase (II).

If an incoming view definition 201 contains an aggregate, grouping, or distinct operator at the top level, its aggregate function is extended (process 220), as explained in Sections 3.4-3.6. The extended view definition 221 is then passed to the population phase (II). The under-aggregate expression will, in general case, undergo the same process 210 of producing the derived expressions 211.

If an incoming view definition 201 contains an aggregate, grouping, or distinct operator under another natural algebra operator, such transformation 230 is performed, as explained in Sections 4.2 and 4.3. and the task is then reduced to the previous one, involving the extension of the aggregate function 220 and producing the derived expressions 210 for the under-aggregate expression.

Finally, if an incoming view definition 201 contains nested aggregate, grouping, or distinct operators and the transformation 230 is not possible, aggregate subviews are extracted. This process 240 is explained in Sections 4.4-4.6. The aggregate subview definitions undergo the same process 220 as the user defined aggregate views, and the under-aggregate expressions are used to produce the derived expressions 211. The original view might either be chosen for materialization or recomputation on demand: the latter option is preferable if (i) the operator applied to the result of aggregation is lightweight, such as projection, or if (ii) the aggregate subview 221 is expected to be drastically more compact in memory then the original view 201, i.e. in case of a join. In that case the original view definition in terms of subviews 241 is passed directly to the update phase (III).

### 1.5.3. Population Phase

The process 260 of populating the original materialized views 201, or extended aggregate views and subviews 221 is preformed by the Execution Engine 140. From the system perspective, the inputs are the optimized view/subview population plans 133, and the process is no different to executing a query plan 131. However, the result of the execution is stored in the Materialized View Storage 160/270, as the contents of the respective materialized views/subviews 161.

Any other views or queries may refer to the stored materialized views in the same way as they refer to the base tables 151, for the benefit of speeding up the execution.

### 1.5.4. Update Phase

The update phase (III) is triggered by the updates to the base tables, formalized as deltas 272, which are extracted by the Delta Extractor 170 upon committing transactions. The process of delta evaluation 250 is performed by the Execution Engine 140 using the IVM plans 134 prepared from the derived expressions 211. The computed deltas are then added (by means of natural union operator) to the materialized views which have been already populated in the storage 270.

In the case of aggregate views or subviews, containing grouping or distinct operator the aggregate update algorithm 280 is invoked, as described in Section 3.6. The inputs are the deltas 272, extended view and subview definitions 221, and the current state of these views and subviews in the storage 270. Whether aggregate or not either case, there new state of the materialized views 271 constitutes the result of our method.

If the aggregate subviews were materialized, and the original view definition in terms of these subviews 241 was chosen for evaluation on demand, such revaluation 290 is typically cheap (or offers another benefit of radically saving space in storage 270 for a maintained subview). In certain cases, such as projection on top of aggregate, such evaluation is not needed at all, as the Execution Engine 140 in some embodiments might not carry any notion of the unused attributes. Anyway, an on-demand view 291 based on maintained aggregate subviews is another possible result of our method.

In the following sections we describe the process of obtaining the derived Natural Algebra expressions. This includes expressions involving the ‘derived’ operators, such as projection, renaming, different kinds of joins (Section 2). In Section 3 we define and study aggregate functions, grouping and distinct operator, and the method for incremental updates to views which feature such an aggregate operation on the top level. In Section 4 we explore different techniques for incremental maintenance of the so-called ‘super-aggregate views’, where the result of an aggregate operation is used for the following computation. The most general technique involves setting up a directed acyclic graph of ‘cascading’ materialized subviews.

### 2. Derived Natural Algebra Expressions

Given a Natural Algebra expression q(A, B, C, . . . ) the process of deriving q^{(A)}, q^{(B)}, etc. is similar to constructing a partial derivative

$$\frac{\partial f}{\partial x}$$

of a function ƒ(x, y, z, . . . ) in the differential calculus.

### 2.1. Basic Derivation Rules

Theorem 2.1. The delta of a Natural Algebra expression is empty (header retained), if the expression is not dependent on the table being changed:

Δ_{A}B=Ø_{H(B)}

Theorem 2.2. The delta of a natural union of Natural Algebra expressions dependent on the table being changed is the natural union of their corresponding deltas:

$${Δ}_{A} {\sum }_{i} {q}_{i} ( A ) = {\sum }_{i} {Δ}_{A} {q}_{i} ( A )$$

Corollary 2.3. The delta of a natural union of a table A being changed and other k-relations is the delta of A projected to the header of the union of those other k-relations:

Δ_{A}(A+B)=Π_{H(B)}(ΔA)

Theorem 2.4. The delta of a natural join of two Natural Algebra expressions ƒ and g dependent on table A is expressed through their respective derivatives ƒ^{(A)} and g^{(A)} as:

Δ_{A}(ƒ(A) [symbol] g(A))=ƒ(A) [symbol] g^{(A)}(A,ΔA)+ƒ^{(A)}(A,ΔA) [symbol] g(A)+ƒ^{(A)}(A,ΔA) [symbol] g^{(A)}(A,ΔA)

Corollary 2.5. The delta of a natural join of a table A being changed and other k-relations is the delta of A joined with the rest of the join arguments:

Δ_{A}(A [symbol] B)=ΔA [symbol] B

Theorem 2.6. The delta of a composition ƒ(g(A)) of two Natural Algebra expressions g(A) and ƒ(G) with known derivatives g^{(A)}(A, ΔA) and ƒ^{(G)}(G, ΔG) is expressed as:

Δ_{A}ƒ(g(A))=ƒ^{(G)}(g(A),g^{(A)}(A,ΔA))

### 2.2. Delta Propagation Through the Derived Operators

Natural Algebra defines a number of derived operators, expressed in terms of the natural join, natural union, and the generated sets.

### 2.2.1. Projection

Definition 2.7. Projection Π_{X}(A) of a k-relation A to a header X retains only the attributes X in A, and does not add any new tuples:

∀A∀X: Π_{X}(A)=A+Ø_{X}

Theorem 2.8. Delta of a projection of a k-relation A to a header X is the projection of its delta:

Δ_{A}Π_{X}(A)=Π_{X}(ΔA)

### 2.2.2. Selection and Extension

A selection operator is expressed through a join with a generated set:

Definition 2.9. Generated set {ƒ(X)}_{X} is a potentially infinite k-relation in the domain Dom(X), containing all those tuples for which the predicate ƒ(X) is true, each with multiplicity of 1.

The set of attributes X outside the curly brackets designates the header of the generated set, and is normally omitted, since the only ‘meaningful’ and necessary attributes are those which are needed to compute ƒ(X).

Definition 2.10. Selection σ_{ƒ(X)}(A) of tuples from a k-relation A based on a predicate ƒ(X) depending on the attributes X⊆H(A) is a natural join of A with the generated set {ƒ(X)}_{X}.

σ_{ƒ(X)}(A)=A [symbol] {ƒ(X)}_{X}

Similarly, an extension of is also expressed as a join with a generated set:

Definition 2.11. Extension of k-relation A with an attribute b H(A) computed as a function ƒ(X) of the existing attributes X⊆H(A) is a natural join of A with the generated set based on the equality predicate b=ƒ(X).

A [symbol] {b=ƒ(X)}_{X∪{b}}

Generated sets, taken as infinite k-relations, do not depend on any stored k-relations, so their deltas are always empty. Consequently, based on Corollary 2.5:

Theorem 2.12. Delta of a generated set joined with a k-relation is the delta of that k-relation joined with the same generated set:

Δ_{A}(A [symbol] {ƒ(X)}_{X})=ΔA [symbol] {ƒ(X)}_{X}

### 2.2.3. Renaming

Definition 2.13. Renaming ρ_{\dot{X}→\dot{Y}}(A) of the attributes specified by vector \dot{X} to the attributes specified by vector \dot{Y} in a k-relation A is defined in terms of a join with a generated set, and a projection:

$${ρ}_{\dot{X} \cdot \to \dot{Y}} ( A ) {=}^{Def} {Π}_{( H ( A ) ∖ X ) ⋃ Y} ( A \{ \begin{matrix}\vert X \vert \\ {∧}_{i = 1}\end{matrix} {b}_{i} = {a}_{i} \} )$$

As follows from the Theorems 2.8 and 2.12:

Theorem 2.14. Delta of a renaming of a k-relation is the renaming of a delta of that k-relation:

Δ_{A}ρ_{\dot{X}→\dot{Y}}(A)=ρ_{\dot{X}→\dot{Y}}(ΔA)

The most frequent use of a renaming operator when translating SQL queries is prefixing, which has its own notation:

ρ_{P.}(A)ρ_{\dot{H}(A)→P.\dot{H}(A)}(A)

where \dot{H}(A) is arbitrarily ordered header of A, and P.\dot{H}(A) is the corresponding vector of attributes in \dot{H}(A) each prefixed with P.

Corollary 2.15. Delta of a prefixed k-relation is the prefixed delta of that k-relation:

Δ_{A}ρ_{P.}(A)=ρ_{P.}(ΔA)

### 2.2.4. Equijoin and Theta-Join

Conditional join operators in Natural Algebra incorporate prefixing and selection of the result, based on a certain condition. Theta-join is the most general case:

Definition 2.16. Theta-join A^{P} [symbol] _{θ(X,Y)}^{Q.}B where an arbitrary join condition θ(X,Y) depends on the attributes X from the left operand, and the attributes Y from the right operand, and (in order to avoid unwanted name collisions), incorporates prefixing of the operand k-relations with P. and Q. prefixes respectively is defined as a natural join of the prefixed k-relations, and the join predicated applied to the prefixed attributes:

A^{P.} [symbol] _{θ(X,Y)}^{Q.}B=ρ_{P.}(A) [symbol] ρ_{Q.}(B) [symbol] {θ(P.X,Q.Y)}

It is regarded as a single derived operator representing the corresponding join operation in query languages, and encapsulates the join condition in order to help the query optimizer to construct an efficient physical plan while avoiding the Cartesian product ρ_{P.}(A) [symbol] ρ_{Q.}(B).

Equijoin is an important particular case of a theta-join, which is offering more immediate opportunities for optimization:

Definition 2.17. Equijoin is a particular case of theta-join, where two aligned vectors of attributes \dot{X}= [symbol] a₁, . . . , aₙ [symbol] and \dot{Y}= [symbol] b₁, . . . , bₙ [symbol] are bound by an equality condition:

$${A}_{\dot{X}}^{P} \cdot {\dot{Y}}_{Q}^{} \cdot B {=}^{Def} {ρ}_{P} \cdot ( A ) {ρ}_{Q} \cdot ( B ) \{ \begin{matrix}\vert \dot{X} \vert \\ {∧}_{i = 1}\end{matrix} P \cdot {a}_{i} = Q \cdot {b}_{i} \}$$

The general case of deltas of theta- and equijoins of arbitrary expressions can derived in a way similar to one in Theorem 2.4. As particular case, based on the Corollaries 2.5, 2.15, and the Theorem 2.12:

Theorem 2.18. Delta of a theta- (equi-) join of a k-relation A being updated and another k-relation B is the same kind of theta- (equi-) join of the delta of the updated k-relation, and the other argument:

Δ_{A}(A^{P.} [symbol] _{θ(X,Y)}^{Q.}B)=ρ_{P.}(A) [symbol] ρ_{Q.}(B) [symbol] {θ(P.X,Q.Y)}

We continue the study of deriving deltas of other special kinds of join operators, including semijoins, antijoins, and various kinds of outer joins in Section 4, after studying the delta propagation through the aggregation, grouping and distinct operators in Section 3.

### 2.3. Examples

This will be our running example through the rest of this disclosure, designed to illustrate delta propagation through different types of Natural Algebra expressions, incremental updates to the materialized views based on this technique. This example in by no means limiting the applicability of our method: as we have already shown in this section, delta propagation is general enough to be applied to any Natural Algebra expressions, which cover all kinds of queries expressible in database query languages.

The scenario covers fruit deliveries being ordered on specific dates. Two base tables, Order (Table 2.1) and Item (Table 2.2) are in master-detail relationship, with Item.order being a foreign key into the Order.key column. Since this reflects a classical relational database scenario, all rows are unique, and thus all multiplicities in the stored tables are set to 1.

TABLE 2.1
Order table

| key | date | # |
|---|---|---|
| 1 | Mar. 30, 2020 | 1 |
| 2 | Apr. 7, 2020 | 1 |
| 3 | Apr. 14, 2020 | 1 |
| 4 | Apr. 21, 2020 | 1 |

TABLE 2.2
Item table

| key | order | price | qty | name | # |
|---|---|---|---|---|---|
| 1 | 1 | 75 | 5 | Watermelon | 1 |
| 2 | 1 | 40 | 3 | Pineapple | 1 |
| 3 | 1 | 20 | 10 | Coconut | 1 |
| 4 | 2 | 30 | 4 | Papaya | 1 |
| 5 | 2 | 55 | 7 | Watermelon | 1 |
| 6 | 2 | 20 | 12 | Coconut | 1 |
| 7 | 3 | 30 | 5 | Papaya | 1 |
| 8 | 3 | 40 | 3 | Papaya | 1 |
| 9 | 3 | 65 | 2 | Watermelon | 1 |

### Example 2.1. Our First Materialized View is Called Po and Lists all Papaya Orders. Here's the SQL Definition

CREATE VIEW Po AS
   SELECT date, price, qty
      FROM Order AS O JOIN item ON O.key=order
   WHERE name=‘Papaya’

and the Natural Algebra definition:

Po(Order,Item)=Π_{{date,price,qty}}(ρo.(Order) [symbol] Item [symbol] {O.key=order} [symbol] {name=‘Papaya’})

The initial content of this view, corresponding to the state of the Order and Item tables is shown in the Table 2.3.

TABLE 2.3
Po view

| date | price | qty | # |
|---|---|---|---|
| 2020 Apr. 07 | 30 | 4 | 1 |
| 2020 Apr. 14 | 30 | 5 | 1 |
| 2020 Apr. 14 | 40 | 3 | 1 |

Two derived expressions for this view definition are based on the Corollary 2.5:

Δ_{Order}Po(Order,Item)=Po^{(Order)}(Order,ΔOrder,Item)==Π_{{date,price,qty}}(ρo.(ΔOrder) [symbol] Item [symbol] {O.key=order} [symbol] {name=‘Papaya’})

ΔᵢₜₑₘPo(Order,Item)=Po^{(Item)}(Order,Item,ΔItem)==Π_{{date,price,qty}}(ρo.(Order) [symbol] ΔItem [symbol] {O.key=order} [symbol] {name=‘Papaya’})

TABLE 2.4
ΔItem table update

| key | order | price | qty | name | # |
|---|---|---|---|---|---|
| 8 | 3 | 40 | 3 | Papaya | −1 |
| 8 | 4 | 20 | 6 | Banana | 1 |

Given the update to the Item table (changing an order for expensive papaya to the cheaper bananas, and putting it in the next order) shown in the Table 2.4, the resulting update to the Po view is:

TABLE 2.5
ΔPo materialized view update

| date | price | qty | # |
|---|---|---|---|
| 2020 Apr. 14 | 40 | 3 | −1 |

### Example 2.2. To Illustrate the Theorems 2.4 and 2.6, Let Us Define Another View Pi to Discover the Increases in Papaya Prices. It Involves a Self-Join Over the Po View

CREATE VIEW Pi AS
   SELECT Po1.date, Po2.date, Po2.price−Po1.price AS increase
      FROM Po AS Po1 JOIN Po AS Po2 ON Po1.date<Po2.date
   WHERE increase>0

which is translated to Natural algebra as:

Pi(Po)Π_{{Po1.date,Po2.date,increase}}(ρ_{Po1.}(Po) [symbol] ρ_{Po2.}(Po) [symbol] J)

where the generated sets are denoted as one subexpression J:

J={Po1.date<Po2.date} [symbol] {increase=Po2.price−Po1.price} [symbol] {increase>0}

TABLE 2.6
Pi materialized view

| | | | |
|---|---|---|---|
| Po1.date | Po2.date | increase | # |

| | | | |
|---|---|---|---|
| 2020 Apr. 07 | 2020 Apr. 14 | 10 | 1 |

In order to derive ΔᵢₜₑₘPi(Po(Order,Item)) we can first construct a derived expression Pi^{(Po)}(Po,ΔPo), based on the Theorem 2.4 and the Corollary 2.15.

Δ_{Po}Pi(Po)=Pi^{(Po)}(Po,ΔPo)=Π_{{Po1.date,Po2.date,increase}}(ρ_{Po1}(ΔPo) [symbol] ρ_{Po2.}(Po) [symbol] J++ρ_{Po1.}(Po) [symbol] ρ_{po2.}(ΔPo) [symbol] J+ρ_{po1.}(ΔPo) [symbol] ρ_{Po2.}(ΔPo) [symbol] J)

In a scenario where the view Po is materialized, this is already sufficient to also maintain Pi, since at any update to the base tables, the current content of Po will be stored and an update ΔPo will be computed. Based on the data in Tables 2.3 and 2.5, ΔPi is easily derived through the latter expression, and shown in Table 2.7.

TABLE 2.7
ΔPi materialized view update

| Po1.date | Po2.date | increase | # |
|---|---|---|---|
| 2020 Apr. 07 | 2020 Apr. 14 | 10 | −1 |

However, in a scenario where Po is non-materialized (effectively a subquery), in order to derive ΔᵢₜₑₘPi(Po(Order,Item)) we use the Theorem 2.6, since both Pi^{(Po)}(Po,ΔPo) and Po^{(Item)}(Order,Item,ΔItem) expressions are derived and known:

Δ_{Item}Pi(Po(Order,Item))=Pi^{(Po)}(Po(Order,Item),Po^{(Item)}(Order,Item,ΔItem))

### 3. Delta Propagation Through Aggregation and Grouping

### 3.1. Aggregate Functions

Definition 3.1. Aggregate function is such a function F that accepts a finite k-relation A containing specific attributes base(F)⊆H(A), and returns a single tuple with header H(F).

Definition 3.2. Single-attribute aggregate function is such an aggregate function F that returns a tuple with a single attribute: |H(F)|=1, and requires at most one attribute in the argument k-relation: |base(F)|≤1.

Single-attribute aggregate functions in Natural Algebra roughly correspond to the well-known aggregate functions in SQL, such as Sum, Max, etc. if the latter are taken together with the names of the input and output attributes. However, they also have access to the multiplicities of tuples. For example, Sum(x) a returns tuple with a single attribute in a numeric domain, and is defined as:

$$Su {m}_{\{ x \}}^{a} ( A ) {=}^{Def} 〈 a \to {\sum }_{t ∈ A} t . x \cdot {k}_{A} ( t ) 〉$$

We will annotate base of an aggregate function as a subscript to its name, and the result header—as a superscript, where needed. We omit the set notation {a} for the headers of single-attribute aggregate functions. The value of attribute x in tuple t is referred to as t.x.

Another example of an aggregate function is Count:

$$C oun {t}_{∅}^{c} ( A ) {=}^{Def} 〈 c \to {\sum }_{t ∈ A} {k}_{A} ( t ) 〉$$

Note that in contrast to the relational algebra setting, in Natural Algebra Count may return a negative value, due to the negative multiplicities in A.

Definition 3.3. Horizontal compounds of aggregate functions. An aggregate function F is called a compound function, if there exist such aggregate functions F′ and F″ for any finite k-relation A, H(A)⊇base(F) that F(A) can be expressed as:

F(A)=F′(A)·F″(A), base(F)=base(F′)∪base(F″),H(F)=H(F′)∪H(F″) (3.1)

and H(F′)∩H(F″)=Ø, i.e. the tuple join operation in (1) is effectively concatenating two tuples resulting from F′ and F″ components.

The ability to make compound functions that operate on k-relations in general allows us to limit the following study to the single-attribute aggregate functions.

### Example 3.1. Avg(x) Function can be Defined with a Horizontal Compound of Sum(x) and Count, Joined with a Generated Set which Implements the ‘Post-Processing’ Logic, and Projected Down to the Avg Attribute

{Avg_{{x}}^{a}(A)}=Π_{{a}}(Sum_{{x}}^{b}(A)·Count_{Ø}^{c}(A) [symbol] a,b,c [symbol] : b=a·c})

Note that we use a singleton k-relation on the left side, since we are dealing with k-relation version of the projection, operating of the result of a join with a generated set.

Definition 3.4. Additive aggregate function. An aggregate function F is additive if there exists such an addition function φ⁺(t,u) that for any finite positive k-relations A and B, H(A)⊇base(F), H(B)⊇base(F), the following holds:

F(A+B)=φ⁺(F(A),F(B))

Theorem 3.5. Any addition function φ⁺(t,u) is commutative and associative:

∀t,uϵDom(H(F)): φ⁺(t,u)=φ⁺(u,t)

∀t,u,vϵDom(H(F)): φ⁺(t,φ⁺(u,v))=φ⁺(φ⁺(t,u),v)

Definition 3.6. Subtractive aggregate function. An aggregate function F is subtractive if there exists such a function φ⁻(t,u) that for any two finite positive k-relations A and B, H(A)⊇base(F), H(B)⊇base(F), the following holds:

F(A−B)=φ⁻(F(A),F(B))

Examples of φ⁺(t,u) and φ⁻(t,u) for some aggregate functions are presented in Table 3.1.

TABLE 3.1
Additive and subtractive aggregate functions

| F | φ⁺(t, u) | φ⁻(t, u) |
|---|---|---|
| Sum(x) | [symbol] Sum → t.Sum + u.Sum [symbol] | [symbol] Sum → t.Sum − u.Sum [symbol] |
| Count( ) | [symbol] Count → t.Count + u.Count [symbol] | [symbol] Count → t.Count − u.Count [symbol] |
| Min(x) | [symbol] Min → mm(t.Min, u.Min) [symbol] | Not subtractive |
| Max(x) | [symbol] Max → max(t, Max, u.Max) [symbol] | |
| Every(x) | [symbol] Every → t.Every ∧ u.Every [symbol] | |
| Some(x) | [symbol] Some → t.Some ∨ u.Some [symbol] | |

### Example 3.2. Aggregate Function Max is Additive but not Subtractive

Given a query
SELECT MAX(price) FROM Po
   corresponding to the Natural Algebra expression) {Max_{price}(Po)}. Given the update ΔPo shown in the Table 2.5, we cannot incrementally compute the new result Max_{price}(Po+ΔPo)= [symbol] 30 [symbol] for this query, based only on Max_{price}(Po)= [symbol] 40 [symbol] and Max_{price}(Po)= [symbol] 40 [symbol] a since the delta ΔPo is not positive.

The same restriction justifies the requirement for A to be positive: otherwise, even with the positive delta some rows might disappear from A+ΔA.

### Example 3.3. At the Same Time, Incrementally Computing the Result of the Query

SELECT SUM(qty) FROM Po
   for the given Po and ΔPo is possible, since the aggregate function Sum is both additive and subtractive, and we can introduce Δ⁻Po=−ΔPo which is positive. Using the subtraction function φ⁻ from the Table 3.1, with Sum_{qty}(Po)= [symbol] 12 [symbol] and Sum_{qty}(Δ⁻Po)= [symbol] 3 [symbol] we incrementally compute

Sum_{qty}(Po−Δ⁻Po)=Sum⁻(Sum_{qty}(Po),Sum_{qty}(Δ⁻Po))= [symbol] 9

[symbol]

3.2. Delta of an Aggregate Function

Delta of the k-relation {F(A)}, which contains the result of applying aggregate function F to a finite k-relation A), under a finite change of ΔA is

Δ_{A}{F(A)}={F(A+ΔA)}−{F(A)}

A non-empty delta of {F(A)} consists of exactly two tuples.

In the following discussion we assume that both A and A+ΔA are positive. This assumption is safe, since in the Natural Algebra setting, we expect only deltas to contain tuples with negative multiplicity.

Theorem 3.7. If an aggregate function F is additive (with φ⁺ defined), then, given a positive change Δ⁺A to a positive k-relation A, H(A)⊇base(F), delta of {F(A)} can be computed using F(A) and F(Δ⁺A):

Δ_{A}{F(A)}={φ⁺(F(A),F(Δ⁺A))}−{F(A)}

Theorem 3.8. If an aggregate function F is additive and subtractive (with φ⁺ and φ⁻ defined), then, given a change ΔA=Δ⁺A−Δ⁻A to a positive k-relation A, H(A)⊇base(F), where both Δ⁺A and Δ⁻A are positive, delta of F(A) can be computed using F(A), F(Δ⁺A), and F(Δ⁻A):

Δ_{A}{F(A)}={F(A+Δ⁺A−Δ⁻A)}−{F(A)}={φ⁻φ⁺(F(A),F(Δ⁺A)),F(Δ⁻A))}−{F(A)}

Note that while the union operands A, Δ⁺A, and −Δ⁻A can be associatively combined in any order, in the formula above we maintain the F((A+Δ⁺A)−Δ⁻A) associative interpretation. This is done in order to avoid passing such F(R) as first argument to φ⁺, φ⁻ where R is not guaranteed to be positive.

Different ways of computing Δ_{A} {F(A)}, under different requirements to F and ΔA are summarized in Table 3.2.

TABLE 3.2
Delta of F(A) under charge ΔA

| Δ_{A}{F(A)} | positive ΔA | any ΔA = Δ⁺A − Δ⁻A |
|---|---|---|
| additive and subtractive F | {φ⁺(F(A), F(ΔA))} − | {φ⁻(φ⁺(F(A), F(Δ⁺A)), F(Δ⁻A))} − {(F(4)} |
| additive F | {F(A)} | |

| | |
|---|---|
| any F | {F(A + ΔA)} − {F(A)} |

### 3.3. Grouping and Distinct Operators

Definition 3.9. Indicator function I(A) returns scalar 0 if its argument is a empty k-relation, and scalar 1 otherwise:

$$I ( A ) {=}^{Def} \vert sgn ( \vert A \vert ) \vert$$

Definition 3.10. Grouping operator Ξ_{G} for the header G is applied to an aggregate function F, base(F)∩G=Ø and a finite k-relation A:

$${Ξ}_{G} ( F , A ) = {\sum }_{t ∈ Dom ( G )} \{ t \cdot F ( A t ) \cdot I ( A t ) \}$$

It produces as many tuples as there are distinct t, tϵΠ_{G}(A), and each of the results is joined with F(A [symbol] t).

### Example 3.4. Consider the Items Table. Let's Say the Domain of the Name Attribute is Limited to a Fixed Enumeration

Dom(name)={‘Banana’,‘Coconut’,‘Papaya’,‘Pineapple’,‘Watermelon’}.

A query computing the total quantity of different items ordered
SELECT name, SUM(qty) AS sq FROM Item GROUP BY name
   translates to Natural Algebra as

Ξ_{{name}}(Sum_{qty}^{qt},Item)

and can be computed, according to the Definition 3.10, group-by-group, as shown in Table 3.3.

TABLE 3.3
Groups of Ξ_{{name}}(Sum_{qty}^{qt}, Item)

| t | Item [symbol] t | | | | | I(Item [symbol] | Sum_{qty}^{qt}(Item |
|---|---|---|---|---|---|---|---|
| name | order | price | qty | name | # | t) | [symbol] t) |
| Banana | Ø | | | | | 0 | [symbol] 0 [symbol] |
| Coconut | 1 | 20 | 10 | Coconut | 1 | 1 | [symbol] 22 [symbol] |
| | 2 | 20 | 12 | Coconut | 1 | | |
| Papaya | 2 | 30 | 4 | Papaya | 1 | 1 | [symbol] 12 [symbol] |
| | 3 | 30 | 5 | Papaya | 1 | | |
| | 3 | 40 | 3 | Papaya | 1 | | |
| Pineapple | 1 | 40 | 3 | Pineapple | 1 | 1 | [symbol] 3 [symbol] |
| Watermelon | 1 | 75 | 5 | Watermelon | 1 | 1 | [symbol] 14 [symbol] |
| | 2 | 55 | 7 | Watermelon | 1 | | |
| | 3 | 65 | 2 | Watermelon | 1 | | |

The result of the natural union across the groups yields the result of the query (Table 3.4). Please note that the [symbol] 0 [symbol] aggregate result for the empty ‘Banana’ group is not included, since the indicator function returned 0.

TABLE 3.4
Result of Ξ_{{name}}(Sum_{qty}^{qt}, Item)

| name | qt | # |
|---|---|---|
| Coconut | 22 | 1 |
| Papaya | 12 | 1 |
| Pineapple | 3 | 1 |
| Watermelon | 14 | 1 |

The grouping operator allows us to define the distinct operator ∥A∥, which is widely used in SQL:

Definition 3.11. Distinct operator ∥A∥, applied to a finite k-relation A is the grouping of all tuples in A on the whole header H(A), with a empty tuple constant [symbol] used as aggregate function:

$$‖ A ‖ {=}^{Def} {Ξ}_{H ( A )} ( 〈 〉 , A ) = {\sum }_{t ∈ Dom ( H ( A ) )} \{ t \cdot I ( A t ) \}$$

Note that the constant aggregate function F(A)= [symbol] is additive, as any tuple is valid as a result of F⁻¹ [symbol] , and subtractive: given F(A′+v) it is possible to compute the result of F(A′). Naturally φ⁺(t,u)= [symbol] and φ⁻(t,u)= [symbol] .

### Example 3.5. The Following SQL Query

SELECT DISTINCT name FROM Item
   translates to a Natural Algebra expression ∥Π_{{name}}(Item)∥. The grouping on the name attribute happens in the same way as illustrated in the Table 3.3, except that the aggregate function always returns [symbol] . The result of the distinct operator consists of the name column in Table 3.4, and multiplicities of 1.

3.4. Delta Propagation Through the Grouping Operator

The delta of a result of the grouping operator Ξ_{G}, applied to an aggregate function F and a finite positive k-relation A is computed on a group-by-group basis:

$$Δ {}_{A} {Ξ}_{G} ( F , A ) = {Ξ}_{G} ( F , A + Δ A ) - {Ξ}_{G} ( F , A ) = {\sum }_{t ∈ Dom ( G )} t ( \{ F ( ( A + Δ A ) t ) \cdot I ( ( A + Δ A ) t ) \} - \{ F ( A t ) \cdot I ( A t ) \} ) = {\sum }_{t ∈ Dom ( G )} t {Δ}_{A} F ( A t ) \cdot I ( A t )$$

Let us consider five different cases, depending on the membership of t:

TABLE 3.5
Delta of F(A [symbol] t) · I(A [symbol] t) under a change ΔA

| | I(A [symbol] t) | I(ΔA [symbol] t) | I(A + ΔA [symbol] t) | Δ_{A}F(A [symbol] t) · I(A [symbol] t) |
|---|---|---|---|---|
| a | 0 | 0 | 0 | 0 · {F(Ø_{H(A)})} − 0 · {F(Ø_{H(A)})} = Ø_{H(F)} |
| b | 0 | 1 | 1 | (F(Ø_{H(A)} + ΔA [symbol] t)} − 0 · {F(Ø_{H(A)})} = {F(ΔA [symbol] t)} |
| c | 1 | 0 | 1 | {F(A [symbol] t + Ø_{H(A)})} − {F(A [symbol] t)} = Ø_{H(F)} |
| d | 1 | 1 | 1 | {F((A + ΔA) [symbol] t)} − {F(A [symbol] t)} = Δ_{A}F(A [symbol] t) |
| e | 1 | 1 | 0 | 0 · {F(Ø_{H(A)})} − {F(A [symbol] t)} = − 1 · {F(A [symbol] t)} |

Cases (a) and (c) are when the group does not join with ΔA, i.e. t∉∥Π_{G}(ΔA)∥, so the result of aggregation of the group remains unchanged.

Case (b) is when we add a new group, case (d) is when we modify an existing group, and case (e) is when we remove a group (may only be possible for non-positive AA, given that A is positive). These are the only three cases where delta

Δ_{A}F(A [symbol] t)·I(A [symbol] t)

of a group is non-empty, and in all these cases tϵ∥Π_{G}(ΔA)∥. Consequently, it is only necessary to enumerate these values of t to compute delta of a grouping operator.

Theorem 3.12. Delta of a grouping operator may be computed by only iterating through the groups corresponding to tϵ∥Π_{G}(ΔA)∥:

$$Δ {}_{A} {Ξ}_{G} ( F , A ) = {\sum }_{t ∈ ‖ {Π}_{G} ( Δ A ) ‖} t {Δ}_{A} F ( A t ) \cdot I ( {A}_{} t )$$

In cases (b) and (e) the delta Δ_{A}F(A [symbol] t)·I(A [symbol] t) a group can be computed based only on the result F(A [symbol] t) of the aggregate function for that group, and the result F(ΔA [symbol] t) of aggregate function for the delta of the same group. Case (d) is governed by the Table 3.2, thanks to the Theorems 3.7 and 3.8.

The remaining problem is telling apart case (d) from (e)—i.e. we need to check whether the new group (3.2) is empty or not:

(A+ΔA) [symbol] t=A [symbol] t+ΔA [symbol] t (3.2)

While we already have ways to compute the new value for the aggregate function over the group, according to the Table 3.2, for example,

F((A+ΔA) [symbol] t)=F(A [symbol] t+Δ⁺A [symbol] t−Δ⁻A [symbol] t)=φ⁻φ⁺(F(A [symbol] t),F(Δ⁺A [symbol] t)),F(Δ⁻A [symbol] t))

for an additive and subtractive F, the fact that the aggregate for the group is the same as the aggregate as of an empty k-relation, does not always mean that the group is empty.

Definition 3.13. Zero-injective aggregate function. An aggregate function F is zero-injective if and only if for any k-relation A known to be positive, the following implication holds:

F(A)=F(Ø_{H(A)})⇒A=Ø_{H(A)}

Sum, for example is not zero-injective, as a non-empty set of input values with positive multiplicities might sum up to zero. However, Count is zero-injective, while also being additive and subtractive.

If an aggregate function F is at least additive, so we can take a shortcut from Theorem 3.7, at least in the case of positive deltas: in order to avoid re-constructing each group (3.2), we will maintain a horizontal compound of F together with Count:

F′=F·Count_{Ø}^{Count}

so that base(F′)=base(F) and H(F′)=H(F)∪{Count}. Such F′ becomes a zero-injective aggregate function, so by comparing the Count attribute in F′((A+ΔA) [symbol] t) to 0, we can see whether we have case (d) or (e), as defined in Table 3.5. If Count for the new group is 0, then the group became empty (case e), and we just need to remove the tuple corresponding to t. If the group is non-empty (case d), we need to also add a new tuple t·F′((A+ΔA) [symbol] t).

### Example 3.6. Consider a View it(Item)=Ξ_{{name}}(Sum_{qty}^{Qt},Item) Listing the Total Quantities Per Item from the Item Table. Its SQL Definition Involves a Query from Example 3.4 Above, and the Initial State of it(Item), Corresponding to the Item Table in Table 2.2 is Shown in the Table 3.6: Note that we Maintain an Aggregate View Extended with Count

It′(Item)=Ξ_{{name}}(Sum_{qty}^{qt}·Count_{Ø}^{Count},Item)

TABLE 3.6
Initial state of the view It′(Item)

| name | qt | Count | # |
|---|---|---|---|
| Coconut | 22 | 2 | 1 |
| Papaya | 12 | 3 | 1 |
| Pineapple | 2 | 1 | 1 |
| Watermelon | 14 | 3 | 1 |

Let us now consider an update ΔItem, as shown in Table 2.4. Thanks to the Theorem 3.12, Incremental computation of It(Item+ΔItem) relies on the iteration of t only across ∥Π_{{item}}(ΔItem)∥, so only two groups from the Table 3.3 are considered for update (Table 3.7):

TABLE 3.7
Groups of Ξ_{{name}}(Sum_{qty}^{qt} · Count_{Ø}^{Count}, Item)

| t | (Item + ΔItem) [symbol] t | | | | | I(Item | Sum_{qty}^{qt} · Count_{Ø}^{Count} |
|---|---|---|---|---|---|---|---|
| name | order | price | qty | name | # | [symbol] t) | ((Item + ΔItem) [symbol] t) |
| Banana | 3 | 20 | 6 | Banana | 1 | 0 | [symbol] 6, 1 [symbol] |
| | 2 | 30 | 4 | Papaya | 1 | | |
| Papaya | 3 | 30 | 5 | Papaya | 1 | 1 | [symbol] 9, 2 [symbol] |
| | 3 | 40 | 3 | Papaya | 1 | | |
| | 3 | 40 | 3 | Papaya | −1 | | |

In both groups I (ΔItem [symbol] t)=1 due to the iteration range. Our extended function Sum_{qty}^{qt}·Count_{Ø}^{Count} is additive and subtractive, so, as indicated by the Table 3.2 there is no need to ever look into the Item table for the purpose of incrementally computing ΔIt′.

First we compute the aggregate function over ΔItem per each group being updated:

Sum_{qty}^{qt}·Count_{Ø}^{Count}((ΔItem) [symbol] [symbol] name→‘Banana’ [symbol] )= [symbol] sq→6,Count→1 [symbol] ,

Sum_{qty}^{qt}·Count_{Ø}^{Count}((ΔItem) [symbol] [symbol] name→‘Papaya’ [symbol] )= [symbol] sq→3,Count→1 [symbol] ,

The ‘Banana’ group corresponds to the case (b) in Table 3.5, where we add a new group, so { [symbol] ‘Banana’, 6,1 [symbol] } is added to ΔIt′.

For the ‘Papaya’ group, using φ⁺ and φ⁻ we incrementally compute

Sum_{qty}^{qt}·Count_{Ø}^{Count}((Item+ΔItem) [symbol] [symbol] name→‘Papaya’ [symbol] )= [symbol] sq→9,Count→2

[symbol]

We infer I((Item+ΔItem) [symbol] [symbol] name ‘Papaya’ [symbol] )=1 due to the incrementally computed Count value, and thus determine that an update to this group corresponds to case (d) in Table 3.4. Hence, we add two more tuples: { [symbol] ‘Papaya’, 9, 2 [symbol] , [symbol] ‘Papaya’,12, 3 [symbol] *−1} to ΔIt′. The incremental update ΔIt′ is now fully computed, as shown in the Table 3.8:

TABLE 3.8
Incremental update ΔIt′, corresponding to ΔItem.

| name | qt | Count | # |
|---|---|---|---|
| Banana | 6 | 1 | 1 |
| Papaya | 9 | 2 | 1 |
| Papaya | 12 | 3 | −1 |

### 3.5. Delta Propagation Through the Distinct Operator

Let's use the general approach from the Section 3.4 on the distinct operator as a particular case:

Δ_{A}∥A∥=Δ_{A}Ξ_{H(A)}( [symbol] [symbol] ,A)

For groups corresponding to each unique tuple tϵDom(H(A)), let's consider the delta of the corresponding group. Case (b) is when new tuples were added to an empty group (a new non-empty group was created), so

Δ_{A}F(A [symbol] t)·I(A [symbol] t)={ [symbol] [symbol] }

Case (d) is when a non-empty group remained non-empty, so according to the Theorem 3.7, the delta for the group is

Δ_{A}F(A [symbol] t)·I(A [symbol] t)=Δ_{A}F(A [symbol] t)={φ⁺(F(A),F(Δ⁺A))}−{F(A)}={ [symbol] }−{ [symbol] }=Ø_{Ø}

Case (e) is when a previously non-empty group becomes empty, because some tuples were cancelled out:

A_{A}F(A [symbol] t)·I(A [symbol] t)=−{ [symbol] }={ [symbol] −1}

However, in order to distinguish between cases (d) and (e), we need to determine for a given tϵA, whether all tuples corresponding to the group defined by t were cancelled out. We extend our aggregate function [symbol] with Count:

F′= [symbol] ·Count=Count

so that in case (b) we get

Δ_{A}F′(A [symbol] t)·I(A [symbol] t)={Count(ΔA [symbol] t)}

similarly, in case (d):

Δ_{A}F′(A [symbol] t)·I(A [symbol] t)=Δ_{A}F′(A [symbol] t)={Count((A+ΔA) [symbol] t)}−{Count(A [symbol] t)}

where Count((A+ΔA) [symbol] t) is easy to incrementally compute for any ΔA since Count is additive and subtractive.

Finally, in case (e):

Δ_{A}F′(A [symbol] t)·I(A [symbol] t)=−{Count(A [symbol] t)}

where Count(A [symbol] t) can be easily extracted from the stored result of Ξ_{H(A)}(Count_{Ø}^{Count}, A) for any given group determined by t.

In other words, incremental maintenance of a view involving a distinct operator is effectively the incremental maintenance of the Count aggregate.

### 3.6. Algorithm for Computing Delta of a Grouping

Let us summarize the above approach in the general case, in the form of an algorithm.

Algorithm 3.1

Input: Aggregate function F, grouping attributes G, positive k-relation A, stored value of Ξ_{G} (F,A), and a k-relation ΔA such that A+ΔA is still positive.

Output: Delta of a grouping operator Δ_{A}Ξ_{G}(F,A) under the change ΔA.

Assumptions: If F is not Count or horizontal compound containing Count aggregate function, we will maintain Ξ_{G} (F·Count_{Ø}^{Count}, A) instead, and later project out the Count attribute in order to return Ξ_{G}(F,A):

Ξ_{G}(F,A)=Π_{G∪H(F)}Ξ_{G}(F·Count_{Ø}^{Count},A)

So we introduce aggregate function F′=F, if Count is part of F, and F′=F·Count_{Ø} otherwise. This lets us assume that our stored Ξ_{G}(F′,A) always contains an attribute corresponding to the result of the Count aggregate function.

We also assume that distinct operator is implemented on the physical level, and can be directly applied to Π_{G}(ΔA)—thus we can use the Theorem 3.12 instead of iterating through the whole domain of grouping attributes.

Step 1. Initialize the result as an empty k-relation with header G∪H(F′), and proceed to Step 2.

Step 2. For each tuple tϵ∥Π_{G}(ΔA)∥:
try to extract the tuple t·F′(A [symbol] t) from the stored Ξ_{G}(F′, A), using attributes in G as a key,
do steps 3-5. When done, return the result.

Step 3. If t·F′(A [symbol] t) was not found in Ξ_{G}(F′, A), compute F′(ΔA [symbol] t), add the tuple t·F′(ΔA [symbol] t) to the result, and return to Step 2.

Step 4. If t·F′(A [symbol] t) was found, add k-tuple −1·t·F′(A [symbol] t) into the result, and proceed to Step 5.

Step 5. Choose one of the following approaches to compute

F′((A+ΔA) [symbol] t):

Branch 5.1. If ΔA [symbol] t is positive and F is additive with φ⁺ defined, compute F′(ΔA [symbol] t) and then

F′((A+ΔA) [symbol] t)=φ⁺(F′(A [symbol] t),F′(ΔA [symbol] t))

Branch 5.2. If F is both additive and subtractive with φ⁺ and φ⁻ defined, split ΔA [symbol] t as

ΔA [symbol] t=Δ⁺A [symbol] t−Δ⁻A [symbol] t

where both Δ⁺A [symbol] t and Δ⁻A [symbol] t are positive k-relations, compute F′(Δ⁺A [symbol] t) and F′(Δ⁻A [symbol] t), and then

F′((A+ΔA) [symbol] t)=φ⁻(φ⁺(F′(A [symbol] t),F′(Δ⁺A [symbol] t)),F′(Δ⁻A [symbol] t))

Branch 5.3. Otherwise, form the group (A+ΔA) [symbol] t according to (3.2) and directly compute the new aggregate value F′((A+ΔA) [symbol] t). Note this is the only case where we actually need to refer to the base tables A.

Step 5. (cont.) If Count attribute in F′((A+ΔA) [symbol] t) is not 0, add tuple t·F′((A+ΔA) [symbol] t) to the result and return to step 2.

### 3.7. Summary on Aggregate Views

In Section 2 we explored the clearly differentiable cases where the delta of an expression (such as a view definition) can be computed via the derived expressions, using only the deltas to base tables for input.

With aggregate functions, as defined in Section 3.1, we can also find cases where delta of an expression cannot be directly computed, such as the case of non-subtractive aggregate functions and non-positive deltas to their arguments (Example 3.2).

Yet another case is grouping and distinct operators (Sections 3.3-3.6), which allows incremental update, computable for result rows corresponding to the groups joining with the delta of its argument k-relation. Even in the worst case (non-additive/non-subtractive aggregate functions), recomputation of the whole result of such expression is not needed, only the relatively small parts (under relatively small deltas) are affected.

However, for the affected result rows computing the delta of an aggregate expression requires the access to the previous value of the aggregate function. If the aggregate function does not qualify the conditions for incremental computation (Table 3.2) the access to the k-relation argument of the grouping/distinct operator is also required, in order to re-compute the group (A+ΔA) [symbol] t and the new aggregate value for the group.

Table 3.9 summarizes the required inputs for the of delta propagation through different kinds of natural algebra expressions discussed so far.

TABLE 3.9
Required inputs to compute a delta of a natural algebra
expression q(A,B, . . . )

| | | inputs to | | |
|---|---|---|---|---|
| view expression q(A, B, . . . ) | | ΔAq(A, B, . . . ) | | |
| operations involved | examples | ΔA | A | q(A, B, . . . ) |
| natural union, natural join, | A+B, A [symbol] B, Π_{X}(A), | + | | |
| projection, selection, | A [symbol] {f(X)}, A [symbol] | | | |
| extension, renaming/ | {b = f(X)}, ρ_{P.}(A), | | | |
| prefixing, equi- and | A^{P.} [symbol] _{δ(X, Y)}^{Q.}B | | | |
| theta join, | | | | |
| aggregate functions which | Sumₓ^{sx}(A) | + | | + |
| are both additive and | | | | |
| subtractive | | | | |
| other aggregate functions | Maxₓ^{mx}(A) | + | +* | + |
| grouping with aggregate | Ξ_{G}(Sumₓ^{sx}, A) | + | | + |
| functions which are | | | | |
| both additive and | | | | |
| subtractive | | | | |
| grouping with other | Ξ_{G}(Maxₓ^{sx}, A) | + | +* | + |
| aggregate functions | | | | |
| distinct | ∥A∥ | + | | + |

The asterisk marks the cases where the input (and the respective re-computation) is not needed in the case of positive AA and additive aggregate function. Also note that in case of grouping and distinct operator, the only parts of A and q(A) which need to be accessed are the parts which join with t, for those tϵ∥Π_{G}(ΔA)∥, or tϵ∥ΔA∥ in the case of the distinct operator.

In the next section we will discuss one more input required for delta propagation for the certain classes of natural algebra expressions, which include semi-, anti-, and different kinds of outer joins.

### 4. Super-Aggregate Views

In Section 3 we studied the incremental maintenance of such materialized views where an aggregate function call, grouping, or distinct operator are at the top level of a Natural Algebra expression defining the view. This covers large class of aggregate views, however, in certain cases the result of an aggregate operation is used for further selection or other join, not necessarily preserving all the rows and columns of that result.

We will call the latter case super-aggregate views, and in this section we explore different Natural Algebra operators forming the expression on top of the aggregate subexpressions.

### 4.1. Projection and Renaming Over Aggregation

In many cases, where we do not have Count as part of the compound aggregate function, we already maintain an extra Count column in an aggregate view, which is not presented to the user. Basically, all grouping and aggregate columns are required for the incremental view maintenance. If any of these columns is projected-out in the query, internally we still maintain a materialized view with a complete set of attributes G∪H (F).

Projection is a cheap operation in the multiset-based data model such as Natural Algebra, where it does not carry the burden of duplicate removal, so its result does not need to be materialized. For a view V(A)=Π_{X}(Ξ_{G}(F,A)) we would still materialize the complete set of columns G∪H(F), and keep the projection Π_{X} as a ‘deterred’, not materialized operation.

The same idea applies to renaming and prefixing: for a view W(A)=ρ_{P.}(Ξ_{G}(F,A)) we materialize the Ξ_{G}(F,A), and deter the renaming/prefixing operation. In embodiments which produce a physical plan involving no table/column identifiers whatsoever (such as Starcounter DBMS), renaming and prefixing do not matter. And for embodiments storing the materialized views column-by-column, projection does not affect the materialization either.

### Example 4.1. An SQL View Definition

CREATE VIEW It2 AS SELECT SUM(qty) AS sq FROM Item
   is same as It in the Example 3.6, but is projects out the grouping attribute name. It translates to a Natural Algebra expression as

It2(Item)=Π_{{sq}}(Ξ_{{name}}(Sum_{qty}^{qt},Item))

Materialization approach is the same as for the It view—we maintain the It′ view instead which has all the grouping {name} and aggregate {sq} columns, and the extra Count column. Projection only affects how this view is presented to the user or application API, or how other queries are type-resolved against this view.

### 4.2. Selection Over Aggregation

All rows from the result of a grouping operator are potentially needed to compute an incremental update. If a materialized view involves a selection on top of aggregation, the key question is whether this selection can be pushed under the aggregation.

Theorem 4.1. If a selection predicate ƒ(X) depends only on the grouping attributes, X⊆G, the selection can be pushed under the aggregation:

Ξ_{G}(F,A) [symbol] {ƒ(X)}=Ξ_{G}(F,A [symbol] {ƒ(X)})

In other words, selection can be pushed under an aggregation, except in cases where it depends on the result of an aggregate function.

Corollary 4.2. Selection over a distinct operator is the distinct of that selection:

∥A∥ [symbol] {ƒ(X)}=∥A∥ [symbol] {F(X)}∥=∥A [symbol] {ƒ(X)}∥

### 4.3. Join Over Aggregation

Selection A [symbol] {ƒ(X)} which was studied in the previous section, is a special kind of a join, that:
has a generated set {ƒ(X)} as one of the operands, which is a kind of ‘constant’ k-relation in Natural Algebra,
does not add any attributes to A,
does not change the multiplicities of tuples selected from A.

The conditions for pushing a general case join Ξ_{G} (F,A) [symbol] B under the grouping operation, so that the result stays the same, are the following:

(a) only the grouping attributes are used for joining: H(B)∩H(F)=Ø
(b) any attributes H(B) \ G originating from B in the result of a join need to be fully functionally dependent (FFD) on the grouping attributes G, so that grouping of A [symbol] B on G∪H(B) will result in exactly the same groups (with respect to the A attributes) as the original grouping of A on G.
(c) not necessary, but sufficient condition: k-relation B is flat, i.e. B=∥B∥.

Theorem 4.3. If a natural join of the result of grouping Ξ_{G}(F,A) and a flat k-relation B depends only on the grouping attributes, and any other attributes in B are fully functionally dependent (FFD) on the grouping attributes, then the join can be pushed under the grouping operator:

Ξ_{G}(F,A) [symbol] B=Ξ_{G∪H(B)}(F,A [symbol] B)

One typical case when the second condition of the Theorem 4.3 is satisfied is when the grouping set G contains a candidate key in B, so that all other attributes in H(B) are dependent on G.

The selection case, formulated in the Theorem 4.1 above is a particular case of this theorem. Another particular case is an extension of the result of the grouping with an extra attribute b∉H(A)∪H(F), defined as a function of attributes X⊆G:

Corollary 4.4. Extension of the result of the grouping, if it has the form b=ƒ(X) and depends only on the grouping attributes, is equivalent to the grouping of that extension:

X⊆G∧b∉H(A)∪H(F): Ξ_{G}(F,A) [symbol] {b=ƒ(X)}=Ξ_{G}(F,A [symbol] {b=ƒ(X)})

Note that this does not cover other forms of extension, which might produce multiple b values for some tuples t e Dom(G) [symbol] A.

In the case of the distinct operator, all attributes participating in a join are the grouping attributes, and since the aggregate function [symbol] is constant, we do not care about having the same groups. Only the flatness condition B=∥B∥ remains, which can be generalized as:

Corollary 4.5. A natural join of a distinct ∥A∥ [symbol] ∥B∥ is equivalent to the distinct operator of the natural join:

∥A∥ [symbol] ∥B∥=∥A [symbol] B∥

Again, selection (Corollary 4.2) and extension b=ƒ(X) are the important particular cases of the flat k-relations being joined.

### Example 4.2. An SQL View Listing the Total Item Quantities Per Order

### CREATE VIEW Iot AS

SELECT O.date, name, sq
   FROM (SELECT order, name, SUM(qty) AS sq FROM Item)
      JOIN Order AS O ON order=O.key
         translates to a Natural Algebra expression

Iot(Item)=Π_{{O.date,name,sq}}(Ξ_{{name,order}}(Sum_{qty}^{qt},Item) [symbol] (ρ_{O.}(Order) [symbol] {order=O.key}))

groups the ordered items by name and order, and computes the total quantity per each group. It then joins the result with Order table to retrieve the date of the order.

This expression satisfies the conditions of the Theorem 4.3, if the Order table is known to be flat (which is typically the case with stored relational tables). Indeed, the natural join is using the common attribute order, (which Order table is effectively extended with), and it is a grouping attribute. O.key is thus fully functionally dependent (FFD) on the grouping attribute and any other attributes in the Order table are transitively dependent on it. This means that for each group of Item table, there is at most one possible value of the date attribute.

Theorem 4.3 allows transforming this super-aggregate view definition to an aggregate one:

Iot(Item)=Π_{{O.date,name,sq}}(Ξ_{{name,order,O.date}}(Sum_{qty}^{qt},Item [symbol] (ρ_{O.}(Order) [symbol] {order=O.key})))

As explained in Section 4.1, the projection is not a problem for maintaining a materialized aggregate view. The actual view to be maintained would have at least O.date, order, name, sq, and Count columns

### 4.4. Materializing Aggregate Subviews

The technique of converting a super-aggregate view to an aggregate one is just one of the possible optimization choices, however beneficial in most cases where this transformation is possible. Especially, if the join is unselective, this allows maintaining a smaller materialized view. compared to storing the result of a join from the original view definition.

However, this is not always possible, and sometimes an aggregation needs to be performed before selection, extension, or a join can take place—for example, if the result of aggregation is used in a join.

### Example 4.3. An SQL View Definition

CREATE VIEW It3 AS
   SELECT name, SUM(qty) AS sq FROM Item GROUP BY name HAVING sq<10
      translates to a Natural Algebra expression

It3(Item)=Ξ_{{name}}(Sum_{qty}^{sq},Item) [symbol] {sq<10}

If we only maintain the materialized view It3, it might not include all the groups that the view It does. Consequently, we do not have, for example Sum_{qty}^{sq}(Item [symbol] ‘Papaya’ [symbol] ) value stored before the ΔItem update arrives and ΔIt3 update needs to be computed. However, after the ΔItem update (one shown in the Table 2.4) the ‘Papaya’ group satisfies the super-aggregate selection criterion, and should be added to the view.

As a general solution to the problem of super-aggregate views, in case when they cannot be converted to the aggregate views, we basically need to materialize the result of every grouping, distinct, or plain aggregate function call operator involved in the view definition.

In the case of Example 4.3, an additional view, corresponding to the Ξ_{{name}}(Sum_{qty}^{qt}, Item) subexpression needs to be materialized, and incrementally updated every time before It3 view can be updated. In general, the dependency graph may be more complex, for example, it might include the dependency both on the subview and on the original table.

In a general scenario, for each super-aggregate materialized view V a directed acyclic graph (DAG) of materialized aggregate subviews is set up, populated, and updated layer-by-layer before the view V is populated and updated.

### Example 4.4. An SQL View Definition, Featuring Only the ‘Unique’ Items Ordered

CREATE VIEW Ui AS
   SELECT * FROM Item (SELECT name, COUNT(*) AS cnt
      FROM Item GROUP BY name) AS IC
      ON name=IC.name
   WHERE IC.cnt=1
      translates to a Natural Algebra expression

Ui(Item)=Item [symbol] ρ_{IC.}(Ξ_{{name}}(Count^{cnt},Item)) [symbol] {name=IC.name} [symbol] {IC.cnt=1}.

The required input to compute ΔᵢₜₑₘUi(Item) is both the delta of an aggregate subview ΔᵢₜₑₘΞ_{{name}}(Count^{cnt}, Item), and the Item table itself, along with its delta. (Theorem 2.4):

ΔᵢₜₑₘUi(Item)=Item [symbol] ρ_{IC.}(Δ_{Item}Ξ_{{name}}(Count^{cnt},Item)) [symbol] J+ΔᵢₜₑₘItem [symbol] [symbol] ρ_{IC.}(Ξ_{{name}}(Count^{cnt},Item)) [symbol] J+ΔᵢₜₑₘItem [symbol] ρ_{IC.}(Δ_{Item}Ξ_{{name}}(Count^{cnt},Item)) [symbol] J

where J is the constant (generated set) part:

J={name=IC.name} [symbol] {IC.cnt=1}.

Defining the aggregate subview IC as

IC(Item)=Ξ_{{name}}(Count^{cnt},Item)

we can now express the original view in terms of two input variables

Ui(Item,IC)=Item [symbol] ρ_{IC.}(IC) [symbol] J.

and obtain two derived expressions:

Δ_{Item}Ui(Item,IC)=Ui^{(Item)}(ΔItem,IC)=ΔItem [symbol] ρ_{IC.}(IC) [symbol] J.

Δ_{IC}Ui(Item,IC)=Ui^{(IC)}(Item,ΔIC)=Item [symbol] ρ_{IC.}(ΔIC) [symbol] J.

In a full materialization scenario, delta propagation through the dependency graph consists of (a) computing ΔᵢₜₑₘIC(Item) according to the Algorithm 3.1, (b) updating the materialized view Ui with Ui^{(item)}(ΔItem,IC), and (c) updating the materialized view Ui with Ui^{(IC)}(Item,ΔIC), where ΔIC=ΔᵢₜₑₘIC(Item). While stage (c) is dependent on stage (a), update paths (a, c) and (b) are independent, and can be performed in parallel as transactions on the materialized Ui.

### 4.5. Semijoin and Antijoin

The semijoin operator in Natural Algebra preserves the header and all multiplicities from the left operand, if there is at least one join-compatible tuple in the right operand. However, multiplicities from the right operand have no impact on the result, as long as they are non-zero:

Definition 4.6. Semijoin.

A [symbol] B=A [symbol] ∥Π_{H(A)}(B)∥

Delta propagation from the left operand is thus similar to delta propagation though a natural join, where the right operand does not depend on the data in A:

Δ_{A}(A [symbol] B)=ΔA [symbol] B

However, delta propagation through the right operand involves computing delta of the result of the distinct operator:

Δ_{B}(A [symbol] B)=A [symbol] Δ_{B}∥Π_{H(A)}(B)∥

This requires the materialization and maintenance of the ∥Π_{H(A)}(B)∥ aggregate subview, which, as we have shown in the Section 3.5, is equivalent to the maintenance of Ξ_{H(A)}(Count_{Ø}^{Count},B), which would effectively contain all columns from H(A)∩H(B), and the total multiplicity for each group of distinct values for these attributes.

### Example 4.5. Consider an SQL View, Listing Only Non-Empty Orders from the Order Table

CREATE VIEW NEo AS
   SELECT * FROM Order AS O
      WHERE EXISTS (SELECT * FROM Item WHERE order=O.key)

This would translate to Natural Algebra as

NEo(Order,Item)=(ρ_{O.}(Order) [symbol] {O.key=order}) [symbol] Item

which, according to the Definition 4.6. above, is equivalent to

NEo(Order,Item)=(ρ_{O.}(Order) [symbol] {O.key=order}) [symbol] ∥Π_{{order}}(Item)∥.

In order to compute the update ΔNEo corresponding the ΔItem change, we need to:
either transform the semijoin expression to a distinct expression according to the Corollary 4.5, thus obtaining an aggregate view (only possible if the Order table is known to be flat):

NEo(Order,Item)=∥(ρ_{O.}(Order) [symbol] {O.key=order}) [symbol] Π_{{order}}(Item)∥.
or maintain an aggregate subview NEo⁽¹⁾(Item)=∥Π_{{order}}(Item)∥, consisting of the order and Count columns While ΔItem is relatively small, Δ_{Item}∥Π_{{order}}(Item)∥ is even smaller, so the query optimizer might choose to evaluate it first during the incremental update to NEo, and then perform an index lookup on the Order table.

Given the ΔItem update as shown in Table 2.4, Δ_{Item}NEo⁽¹⁾=Δ_{Item}∥Π_{{order}}(Item)∥={ [symbol] (order→4 [symbol] },

so the update to NEo is the row from the renamed Order table, where key=4:

Δ_{Item}NEo(Order,Item)=(ρ_{O.}(Order) [symbol] {O.key=order}) [symbol] { [symbol] order→4 [symbol] }

There is also a complementary operation to semijoin, known as antijoin:

Definition 4.7. Antijoin.

A [symbol] B=A−A [symbol] B=A−A [symbol] ∥Π_{H(A)}(B)∥

Similarly, to the semijoin case, delta propagation through the left operand is non-problematic, and follows from the Corollaries 2.3 and 2.5:

Δ_{A}(A [symbol] B)=ΔA−ΔA [symbol] ∥Π_{H(A)}(B)∥=ΔA [symbol] B

In the case of a change to the right operand, the problem of the delta propagation is equivalent to similar to one for semijoin, except for the scalar multiplication to −1.

Δ_{B}(A [symbol] B)=−Δ_{B}(A [symbol] B)=−A [symbol] Δ_{B}∥Π_{H(A)}(B)∥.

While the stored table A can be big, and Δ_{B}∥Π_{H(A)}(B)∥ is typically smaller than ΔB, we might opt for materializing only the aggregate part of the original expression, incrementally computing the deltas, and then use logarithmic time indexed access into A (provided the join attributes are indexed) to compute the delta of a join.

On the other hand, maintaining a materialized view where the top expression is semijoin or antijoin with a stored table as a left operand can be done with a relatively small memory overhead. Since the result of A [symbol] B and A [symbol] B is always a subset of tuples in A, and no new attributes are added, the materialized view can be implemented as another access path (index) structure into a subset of A.

### Example 4.6. Consider an SQL View, Listing Only Empty Orders from the Order Table

CREATE VIEW Eo AS
   SELECT * FROM Order AS O
      WHERE NOT EXISTS (SELECT * FROM Item WHERE order=O.key)

This would translate to Natural Algebra as

Eo(Order,Item)=O′(Order) [symbol] Item

where O′(Order)=(ρ_{O.}(Order) [symbol] {O.key=order}). According to the Definition 4.7,

Eo(Order,Item)=O′(Order)−O′Order) [symbol] ∥Π_{{order}}(Item)∥

and, if the Order table is known to be flat, O′(Order) is flat too, based on Corollary 4.5

Eo(Order,Item)=O′Order)−∥O′(Order) [symbol] Π_{{order}}(Item)∥

If there is no flatness guarantee for Order table, both techniques for semijoin/antijoin materialization are applicable:

1. Non-materialization of Eo, assuming the Order table is indexed on the key column. An aggregate subexpression Eo⁽¹⁾=∥Π_{{order}}(Item)∥ can be maintained and incrementally updated as described in Section 3.5. The whole expression O′(Order) is effectively just a renaming of the Order table (and a ‘attribute copy’ extension), which only affects the headers, and not performed at all in some embodiments during the execution level. Once the set of values for the join attribute key is known, it takes a logarithmic time to compute each row in

O′(Order) [symbol] ∥Π_{{order}}(Item)∥,

and also in

Eo(Order,Item)=O′(Order)−O′Order) [symbol] ∥Π_{{order}}(Item)∥

2. Materialization as a subset. The subsets of the Order table, corresponding to the semijoin and antijoin with Item table can be materialized by e.g. an injective index pointing into the same storage structure.

In our example, the original content of Eo would consist of the row with key=4 (see Table 2.1) and Eo⁽¹⁾(Item) would initially contain order values 1, 2, and 3.

Following the update ΔItem (Table 2.4), the corresponding change AᵢₜₑₘEo⁽¹⁾(Item) would consist of [symbol] order→4 [symbol] , and the update to the result of the semijoin Δ_{Item} (O′(Order) [symbol] Item) would consist of the Order row with key=4 (with ‘delayed’ renaming and extension, if at all required by the particular embodiment at that stage).

Similarly, the update to the Eo view: AᵢₜₑₘEo=−Δᵢₜₑₘ(O′(Order) [symbol] Item) would contain the same row with key=4 and multiplicity of

### 4.6. Outer Joins

Natural Algebra defines left, right, and full outer join operators, for compatibility with the existing query languages such as SQL and SPARQL. Each of these operations retains all the tuples from one of the operands, possibly repeating them, the way natural join does. If there is no join-compatible tuple in another operand, the remaining attribute values are filled with a special Null value, which belongs to every attribute domain.

Definition 4.8. Null tuple with header X maps every attribute in its header to the Null value:

Null_{X}= [symbol] {(aᵢ→Null): aᵢϵX}

[symbol]

Definition 4.9. Left join A [symbol] B is a natural union of a natural join and the antijoin A [symbol] B extended with a Null tuple for the attributes originating from B:

A [symbol] B=A [symbol] B+(A [symbol] B) [symbol] Null_{H(B)\H(A)}

Definition 4.10. Right join A [symbol] B is a natural union of a natural join and the antijoin B [symbol] A extended with a Null tuple for the attributes originating from A:

A [symbol] B=A [symbol] B+(B [symbol] A) [symbol] Null_{H(A)\H(B)}

Definition 4.11. Full outer join A [symbol] B is a natural union of a natural join and the two extensions specific to the left and right joins:

A [symbol] B=A [symbol] B+(A [symbol] B) [symbol] Null_{H(B)\H(A)}+(B [symbol] A) [symbol] Null_{H(A)\H(B)}

The two easy cases of delta propagation through the outer joins are

Δ_{A}(A [symbol] B)=ΔA [symbol] B

Δ_{B}(A [symbol] B)=A [symbol] ΔB

All other cases involve one or more aggregate subexpressions, which need to be separately maintained. For example

Δ_{B}(A [symbol] B)=A [symbol] ΔB+Δ_{B}(A−A [symbol] ∥Π_{H(A)}(B)∥) [symbol] Null_{H(B)\H(A)}==A [symbol] ΔB−Δ_{B}∥Π_{H(A)}(B)∥ [symbol] Null_{H(B)\H(A)}

Similarly to the semijoin and antijoin cases in the previous sections, the technique of materializing and incrementally maintaining aggregate (distinct) subexpressions Δ_{B}∥Π_{H(A)}(B)∥ and Δ_{A}∥Π_{H(B)}(A)∥ with one or few attributes, is essential for the incremental maintenance of views involving the outer joins.

### 4.7. Summary on Super-Aggregate Views

In this section we discussed three basic techniques for incrementally maintaining the super-aggregate views, i.e. the views involving other Natural Algebra operations on top of the result of aggregation, grouping, or distinct operators.

1. Transformation of such expressions to ones where the aggregate operation is on top (e.g. moving selection, extension, and join operations under the aggregation where possible). In a general join case this requires the knowledge about the flatness guarantees, which can be inferred by the query optimizer in certain embodiments.

2. Materializing aggregate subviews, where a materialized super-aggregate view entails a directed acyclic graph (DAG) of the aggregate views it depends upon. Deltas are propagated to these prerequisite views first, and then to the user defined super-aggregate view.

3. Delayed operations, which are not ‘materialized’ in the view, but computed on demand if at all. These are either header-only operations (such as projection and renaming), which some embodiments do not need to execute, since no column identifiers are involved in the execution. This is also valid for operations such as natural join A [symbol] q(B) or natural union or subtraction, e.g. A−q(B), which may produce a much bigger k-relation than the maintained aggregate subexpression q(B), and at the same time are cheap to execute, due to the logarithmic cost of an access path involved.

The choice between these three techniques can be delegated to a DBA or a specialized ‘view maintenance optimizer’ component, which can decide based on the available statistics, known workload, and the ensuing estimates of the memory and CPU costs.

We have also defined the semijoin, antijoin, and outer joins operations, all of which are based on the distinct operator, and may require the maintenance of the ‘projection-distinct’ views. The materialization of a view with semijoin or antijoin operation on top, and left operand being a stored k-relation or another materialized view, can be easily achieved by enumerating a subset of tuples of that left operand, possibly by an ‘injective index’ pointing to that subset.

The table 3.9, summarizing the techniques explained in Sections 2 and 3, can now be extended with two more rows, featuring super-aggregate expressions. There are also more options for views to materialize, and more diverse update techniques are required. Table 4.1. provides such an overview.

TABLE 4.1
Summary of the proposed techniques for incremental view maintenance

| view expression | inputs to Δ_{A}q(A, B, . . . ) | | | views to | update |
|---|---|---|---|---|---|
| q(A, B, . . . ) | ΔA | A | q(A, B, . . . ) | maintain | technique |
| non-aggregate: natural | + | | | q(A, B, . . . ) | derived |
| union, natural join, | | | | | expressions |
| projection, selection, | | | | | q^{(A)}(A, B, . . . ), |
| extension, renaming, | | | | | q^{(B)}(A, B, . . . ), . . . |
| equi- and theta join | | | | | |
| aggregate call | + | +* | + | q(A, B, . . . ) | Table 3.2 |
| grouping | + | +* | + | q(A, B, . . . ) | Algorithm 3.1 |
| distinct | + | | + | or count-extended | |
| | | | | q′(A, B, . . . ) | |
| super-aggregate | + | +** | | subviews | Algorithm 3.1 |
| (materialized): | | | | q⁽ⁱ⁾(A, B, . . . , q^{(k)}, . . . ) | runtime delta |
| joins over aggregates, | | | | original view | propagation via |
| semi-, anti-, outer joins | | | | q̅(A, B, . . . , q^{(k)}, . . . ) | DAG of subviews |
| super-aggregate | + | +** | | subviews | Algorithm 3.1 |
| (delayed): | | | | q⁽ⁱ⁾(A, B, . . . , q^{(k)}, . . . ) | runtime delta |
| projections, renames, | | | | | propagation via |
| selections, extensions, | | | | | DAG of subviews, |
| natural unions | | | | | on-demand |
| over aggregates | | | | | q̅(A, B, . . . , q^{(k)}, . . . ) |

The asterisk * marks the cases where the input (and the respective re-computation) is not needed in case of additive and subtractive aggregate function, or in case of positive ΔA and additive aggregate function.

The double asterisk ** marks the cases where, in addition to the asterisk-marked restriction, the input might also be needed if the super-aggregate expression involves the table A being changed. Examples of such super-aggregate expressions are outer joins, also selections from the original tables based on the result of their aggregation, such as Example 4.4.

That which is claimed is:

1. A database system comprising:
one or more servers communicatively coupled to each other, each server comprising a non-transitory computer-readable medium and one or more processors, wherein:
a first subset of the one or more servers comprises a storage engine subsystem, the storage engine subsystem configured to:
maintain original data in one or more base tables, and
generate and store materialized views and subviews;
a second subset of the one or more servers comprises a diff engine subsystem configured to receive and translate Natural Algebra representations of a Natural Algebra view definition into corresponding derived Natural Algebra expressions;
a third subset of the one or more servers comprises an Optimizer configured to receive and translate derived Natural Algebra expressions into Incremental View Maintenance plans (134);
a fourth subset of the one or more servers comprises a delta extractor subsystem configured to extract transactional changes to the original data or batches of the transactional changes in a form that can be passed as input to the Incremental View Maintenance plans in order to compute the changes to the materialized views; and
a fifth subset of the one or more servers comprises a database query system configured to:
receive database queries and transactions according to one or more supported database query languages;
translate the database queries and transactions into the Natural Algebra;
generate database plans based on the translated database queries and translations; and
execute the database plans.

2. The system of claim 1, wherein the diff engine subsystem is further configured to handle aggregate views, wherein aggregate views are views containing calls to aggregate functions, grouping operator, and distinct operator, by producing definitions of the aggregate subviews to materialize.

3. The system of claim 2, where the aggregate views to materialize form a directed acyclic graph of dependencies, with input nodes corresponding to the stored base tables, and the output node corresponding to the original user-defined aggregate view, so that and all these aggregate views may be updated incrementally with the aggregate update algorithm and where changes propagate from the input nodes towards the output node.

4. A method comprising,
maintaining, by a database system. original data in one or more base tables;
producing, by the database system for each view definition, one or more derived expressions for each base table in the respective view definition;
generating, by the database system, one or more materialized views in the storage;
populating, by the database system, the one or more materialized views according to the view definitions;
extracting, by the database system, the changes to the original tables each time a transaction commits,
in response to a non-empty change to any of the base tables, incrementally updating, by the database system, the respective base tables by evaluating the derived expressions based on the non-empty changes to the original tables.

5. The method of claim 4, further comprising:
maintaining materialized views whose definitions contain as a top operator an aggregate function call, or a grouping operator, or a distinct operator;
extending the aggregate function in the view definition with count column if the aggregate function lacks a count column,
counting potentially duplicate tuples,
allocating the aggregate materialized views in the storage,
populating the said aggregate materialized views according to the extended view definitions, and
each time a transaction commits, incrementally updating the said aggregate materialized views according to an aggregate update algorithm, wherein the aggregate update algorithm identifies only those rows in the said views which receive a change in result of a given update.

6. The method of claim 4, further comprising:
maintaining materialized views whose original definitions may contain any number of aggregate function calls, grouping operators, and distinct operator at arbitrary levels;
extracting from the original materialized view definition definitions for aggregate subviews, each aggregate subview containing a single aggregate function call, grouping, or distinct operator on top of its expression, and one or more aggregate subviews dependent on other aggregate subviews, thus forming a directed acyclic graph of dependencies,
extending the aggregate function in each materialized subview definition with a count column if the aggregate function lacks a count column,
allocating the aggregate materialized subviews in the storage,
populating the aggregate materialized subviews according to the extended view definitions,
each time a transaction commits, incrementally updating each of the said materialized subviews according to the aggregate update algorithm, the incrementally updating beginning with materialized subviews that do not depend on other materialized subviews, and subsequently propagating the resulting changes to the next layer of subviews in the dependency graph, and
incrementally updating the original materialized view if it was allocated in the storage, or
re-evaluating the original view definition now expressed in terms of the materialized subviews to obtain a cheap-to-execute on-demand view.

7. A non-transitory computer-readable medium comprising processor-executable instructions configured to cause one or more processors to:
execute a database
maintain original data in one or more base tables;
produce, for each view definition, one or more derived expressions for each base table in the respective view definition;
generate one or more materialized views in the storage;
populate the one or more materialized views according to the view definitions;
extract the changes to the original tables each time a transaction commits,
in response to a non-empty change to any of the base tables, incrementally update the respective base tables by evaluating the derived expressions based on the non-empty changes to the original tables.

8. The non-transitory computer-readable medium of claim 7, further comprising processor-executable instructions configured to cause the one or more processors to:
maintain materialized views whose definitions contain as a top operator an aggregate function call, or a grouping operator, or a distinct operator,
extend the aggregate function in the view definition with count column if the aggregate function lacks a count column,
count potentially duplicate tuples,
allocate the aggregate materialized views in the storage,
populate the said aggregate materialized views according to the extended view definitions, and
each time a transaction commits, incrementally update the said aggregate materialized views according to an aggregate update algorithm, wherein the aggregate update algorithm identifies only those rows in the said views which receive a change in result of a given update.

9. The non-transitory computer-readable medium of claim 7, further comprising processor-executable instructions configured to cause the one or more processors to:
maintain materialized views whose original definitions may contain any number of aggregate function calls, grouping operators, and distinct operator at arbitrary levels;
extract from the original materialized view definition definitions for aggregate subviews, each aggregate subview containing a single aggregate function call, grouping, or distinct operator on top of its expression, and one or more aggregate subviews dependent on other aggregate subviews, thus forming a directed acyclic graph of dependencies,
extend the aggregate function in each materialized subview definition with a count column if the aggregate function lacks a count column,
allocate the aggregate materialized subviews in the storage,
populate the aggregate materialized subviews according to the extended view definitions,
each time a transaction commits, incrementally update each of the said materialized subviews according to the aggregate update algorithm, the incrementally updating beginning with materialized subviews that do not depend on other materialized subviews, and subsequently propagating the resulting changes to the next layer of subviews in the dependency graph, and
incrementally update the original materialized view if it was allocated in the storage, or
re-evaluate the original view definition now expressed in terms of the materialized subviews to obtain a cheap-to-execute on-demand view.
